(19) United States
(12) Patent Application Publication
(10) Pub. No.: US 2013/0215966 A1
(43) Pub. Date: Aug. 22, 2013

(54) IMAGE ENCODING METHOD, IMAGE DECODING METHOD, IMAGE ENCODING DEVICE, IMAGE DECODING DEVICE

(71) Applicant: FUJITSU LIMITED, (US)

(72) Inventors: Hidenobu Miyoshi, Kawasaki (JP); Junpei Koyama, Shibuya (JP); Kimihiko Kazui, Kawasaki (JP); Satoshi Shimada, Kawasaki (JP); Akira Nakagawa, Sagamihara (JP)

(73) Assignee: FUJITSU LIMITED, Kawasaki-shi (JP)

(21) Appl. No.: 13/850,050

(22) Filed: Mar. 25, 2013

Related U.S. Application Data
(63) Continuation of application No. PCT/JP2010/067165, filed on Sep. 30, 2010.

(51) Int. Cl. H04N 7/26

(52) U.S. Cl. CPC H04N 19/00569
USPC 375/240.15

(57) ABSTRACT

A method including acquiring decode information of a decoded block in a decode target image from a storage unit; selecting an decoded image such that the decode target image is situated between the decoded image and a reference image of the decoded image; acquiring, from the storage unit, decode information of a predetermined block in the selected decoded image; predicting a reference mode indicating a prediction direction of a decode target block that refers to decoded images in plural directions, by using the acquired decode information of the decoded block and decode information of the predetermined block; decoding reference mode information for determining the reference mode of the decode target block from encode data; and determining the reference mode of the decode target block from the predicted reference mode and the decoded reference mode information.

### CROSS-REFERENCE TO RELATED APPLICATION

This patent application is based upon and claims the benefit of priority under 35 USC 120 and 365(c) of PCT application JP2010/067165 filed in Japan on Sep. 30, 2010, the entire contents of which are incorporated herein by reference.

### FIELD

The embodiments discussed herein are related to an image decoding method, an image encoding method, an image decoding device, and an image encoding device relevant to the prediction of a reference mode.

### BACKGROUND

Image data, particularly video image data generally includes a large amount of data. Therefore, when the image data is transmitted from a sending device to a receiving device, or when the image data is stored in a storage device, high-efficiency encoding is performed. Here, “high-efficiency encoding” is an encoding process of converting a certain data row into another data row, for compressing the data amount.

There is video image data that is constituted mainly by frames, and video image data that is constituted by fields.

As a high-efficiency encoding method for video image data, there is known an intra-picture prediction (intra prediction) encoding method. This encoding method makes use of the fact that the video image data has high correlation in the spatial direction, and an encode image of another picture is not used. By the intra-picture prediction encoding method, it is possible to restore an image only by information in the picture.

Furthermore, there is known an inter-picture prediction (inter prediction) encoding method. This encoding method makes use of the fact that video image data has high correlation in the temporal direction. In video image data, the picture data at a certain timing and the picture data of the next timing often generally have a high degree of similarity. The inter prediction encoding method makes use of this characteristic.

In the inter-picture prediction encoding method, the original image is divided into blocks and an area similar to the original image block is selected from a decode image of a frame that has been encoded, in units of blocks. Next, the difference between the similar area and the original image block is obtained, and redundancy is removed. Then, by encoding the motion vector information indicating the similar area and the difference information from which redundancy is removed, a high compression rate is realized.

For example, in a data transmission system using an inter prediction encoding method, a transmitting device generates motion vector data expressing the “motion” from a previous picture to a target picture, and difference data expressing the difference between a prediction image of a target picture created by using the motion vector data from the previous picture, and the target picture. Next, the data transmission system sends the motion vector data and the difference data to a receiving device. Meanwhile, the receiving device reproduces a target picture from the received motion vector data and difference data.

As a representative example of a video image encoding method, there is ISO/IEC (ISO/IEC: International Organization for Standardization/International Electrotechnical Commission) MPEG (Moving Picture Experts Group)-2/MPEG-4 (hereinafter, “MPEG-2, MPEG-4”).

The video image encoding method has a GOP (group of pictures) structure in which a screen that has been subjected to intra prediction encoding at a constant frequency is sent, and the remainder is sent by inter prediction encoding. Furthermore, three types of pictures I, P, B are defined in correspondence to these predictions. An I picture does not use an encode image of another picture. An I picture is a picture by which an image may be restored only by information in the picture. A P picture is formed by performing inter-picture prediction from a past picture in a forward direction, and encoding the prediction error. A B picture is formed by performing bidirectional (two-way direction) inter-picture prediction, from a past picture and a future picture, and encoding the prediction error. A B picture uses a future picture for prediction, so before the B picture is encoded, the future picture used for prediction is to be encoded and decoded.

FIG. 1 illustrates a B picture that refers to a bidirectional decode image. As illustrated in FIG. 1, at the time point of encoding a B picture Pic2 that is an encode target, at least two pictures Pic1 and Pic3 before and after the B picture Pic2 have been encoded beforehand. The encode target B picture Pic2 may select one of or both of the forward reference picture Pic1 and the backward reference picture Pic3. For example, with the use of a block matching technology, an area in the forward reference picture Pic1 that is most similar to an encode target block CB1 is calculated as a forward direction prediction block FB1, and an area in the backward reference picture Pic3 that is most similar to an encode target block CB1 is calculated as a backward direction prediction block BB1. When both directions are selected, bidirectional information expressing the prediction directions; motion vectors MV1, MV2 that extend from positions in both reference images (Collocated blocks COlB1, COlB2), which are the same as that of the encode target block CB1, to the prediction blocks; and the pixel differences between the encode target block CB1 and the prediction blocks, are encoded.

FIG. 2 illustrates an example of a GOP configuration (part 1). The GOP configuration illustrated in FIG. 2 indicates a typical IBBP structure of a GOP configuration. In MPEG-2, an image that has been encoded and that may be used as a reference image of a B picture is to be encoded as a P picture or an I picture. However, in the latest encoding method, the international standard ITU-T H.264 (ITU-T: International Telecommunication Union Telecommunication Standardization Sector)/ISO/IEC MPEG-4AVC (hereinafter, “H.264”), a decode image of an image that has been encoded with the B picture is additionally used as a reference image.

FIG. 3 illustrates an example of a GOP configuration (part 2). In H.264 for encoding video images, a GOP configuration as illustrated in FIG. 3 may be applied, so that the encoding efficiency is successfully increased. This GOP configuration is referred to as a hierarchical B structure. As described above, the pictures in one GOP include a large number of B pictures, and therefore increasing the encoding efficiency of B pictures directly leads to increasing the efficiency of encoding the entire video image. The arrows in FIGS. 2 and 3 express vectors of the forward direction or the backward direction.

In H.264, the B picture may select prediction direction information (hereinafter, also referred to as a “reference mode”), indicating which one of a forward direction image, a backward direction image, or bidirectional images, is to be used as a reference image (reference images) for each divided block. In H.264, these reference modes and other prediction information are collectively encoded as a macro block type, and are explicitly transmitted as a bit stream.

Here, there is a technology for determining the prediction mode of intra prediction and inter prediction of an encode target block, by setting adjacent blocks as reference blocks, and determining the reference mode to that of the reference block having minimum cost if a predetermined condition is satisfied. Furthermore, in a pre-encoding process of an encode target picture, there is a technology of using the statistic amount of the encoding result of an picture that has been encoded to determine the picture type of the encode target picture.

Furthermore, in a next generation encoding method, there is proposed a technology of performing prediction encoding by predicting the forward direction, the backward direction, and a two-way direction, by using encode information of blocks that have been encoded around an encode target block of an encode target picture, and explicitly sending the reference mode by a bit stream.
Patent document 1: Japanese Laid-Open Patent Publication No. 2009-55542
Patent document 2: Japanese Laid-Open Patent Publication No. 2009-296328
Non-patent document 1: Joint Collaborative Team on Video Coding (JCT-VC) of ITU-T SG16 WP3 and ISO/IEC JTC1/SC29/WG11, 1st Meeting: Dresden, DE, 15-23 Apr. 2010, Appendix to Description of video coding technology proposal by Tandberg Nokia Ericson, JCTVC-A119, P34

However, in the above conventional technology, it is difficult to appropriately predict an encode target block only by spatial prediction of using blocks that have been encoded around an encode target block of an encode target picture. If an encode target block is not appropriately predicted, it is difficult to increase the prediction precision of the reference mode, and it is not possible to improve the encoding/decoding efficiency.

### SUMMARY

According to an aspect of the embodiments, a method for decoding an image divided into a plurality of blocks includes acquiring decode information of a block that has been decoded in a decode target image, from a storage unit storing the decode information of the block that has been decoded and decode information of each block in an image that has been decoded; selecting, from a plurality of the images that have been decoded, an image that has been decoded, such that the decode target image is situated between the selected image that has been decoded and a reference image of the selected image that has been decoded; acquiring, from the storage unit, decode information of a predetermined block in the selected image that has been decoded; predicting a reference mode indicating a prediction direction of a decode target block that is able to refer to images that have been decoded in plural directions, by using the acquired decode information of the block that has been decoded and the acquired decode information of the predetermined block; decoding reference mode information for determining the reference mode of the decode target block from encode data; and determining the reference mode of the decode target block from the reference mode that has been predicted and the reference mode information that has been decoded.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates a B picture that refers to a bidirectional decode image;

FIG. 2 illustrates an example of a GOP configuration (part 1);

FIG. 3 illustrates an example of a GOP configuration (part 2);

FIG. 4 is a block diagram of an image encoding device according to a first embodiment;

FIG. 5 is a block diagram of functions relevant to prediction of a reference mode according to the first embodiment;

FIG. 6 is a block diagram of functions of a prediction unit according to the first embodiment;

FIG. 7 is a block diagram of an image decoding device according to a second embodiment;

FIG. 8 is a block diagram of functions relevant to prediction of a reference mode according to the second embodiment;

FIG. 9 illustrates a GOP configuration used in the embodiments;

FIG. 10 illustrates the relationship between an encode target block and surrounding blocks (part 1);

FIG. 11 is for describing the interval between an image that has been encoded and a reference image of the image that has been encoded;

FIG. 12 illustrates a block located at the same position as an encode target block;

FIG. 13 illustrates a process performed by a second reference mode prediction unit according to a third embodiment;

FIGS. 14A and 14B illustrate the reference mode and the division mode being encoded as a block type;

FIG. 15 is a flowchart of a reference mode encoding process according to the third embodiment;

FIG. 16 is a flowchart of a reference mode decoding process according to a fourth embodiment;

FIG. 17 illustrates the relationship between an encode target block and surrounding blocks (part 2);

FIG. 18 illustrates an example of the relationship between the Collocated block and surrounding blocks;

FIG. 19 illustrates a process performed by a second reference mode prediction unit according to a fifth embodiment;

FIGS. 20A and 20B indicate a flowchart of a reference mode encoding process according to the fifth embodiment;

FIGS. 21A and 21B indicate a flowchart of a reference mode decoding process according to a sixth embodiment;

FIG. 22 is a block diagram of functions relevant to prediction of a reference mode according to a seventh embodiment;

FIG. 23 illustrates a selection process of an image that has been encoded according to the seventh embodiment;

FIG. 24 illustrates a process performed by a first acquiring unit according to the seventh embodiment;

FIG. 25 illustrates an example of a tentative motion vector;

FIG. 26 is a block diagram of the prediction unit 504 according to the seventh embodiment

FIGS. 27A and 27B indicate a flowchart of a reference mode encoding process according to the seventh embodiment;

FIG. 28 is a block diagram of functions relevant to prediction of a reference mode according to an eighth embodiment;

FIGS. 29A and 29B indicate a flowchart of a reference mode decoding process according to the eighth embodiment; and

FIG. 30 is a block diagram of an example of an information processing device.

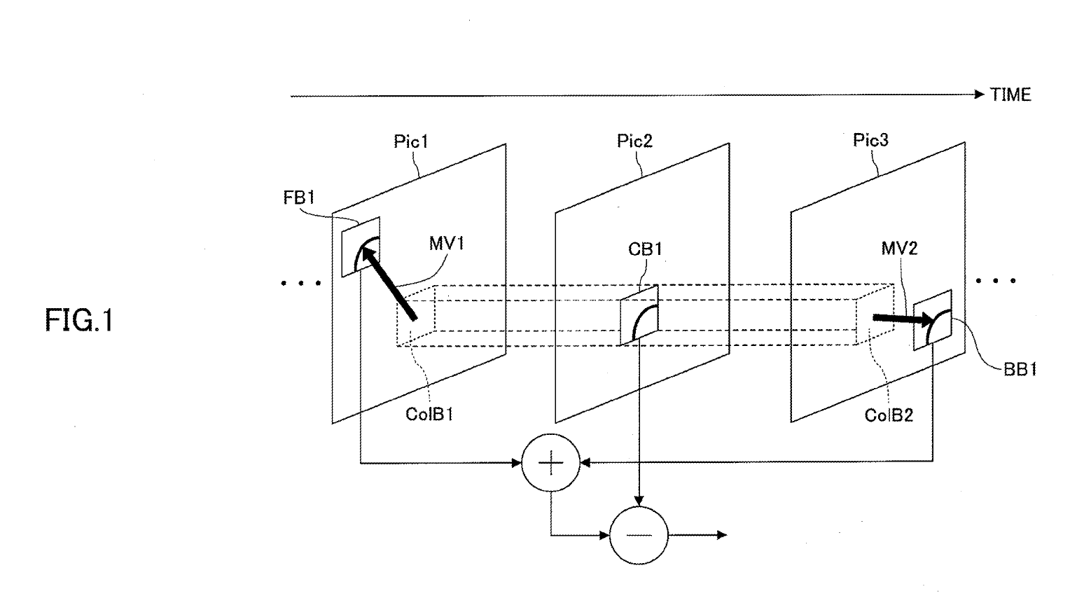

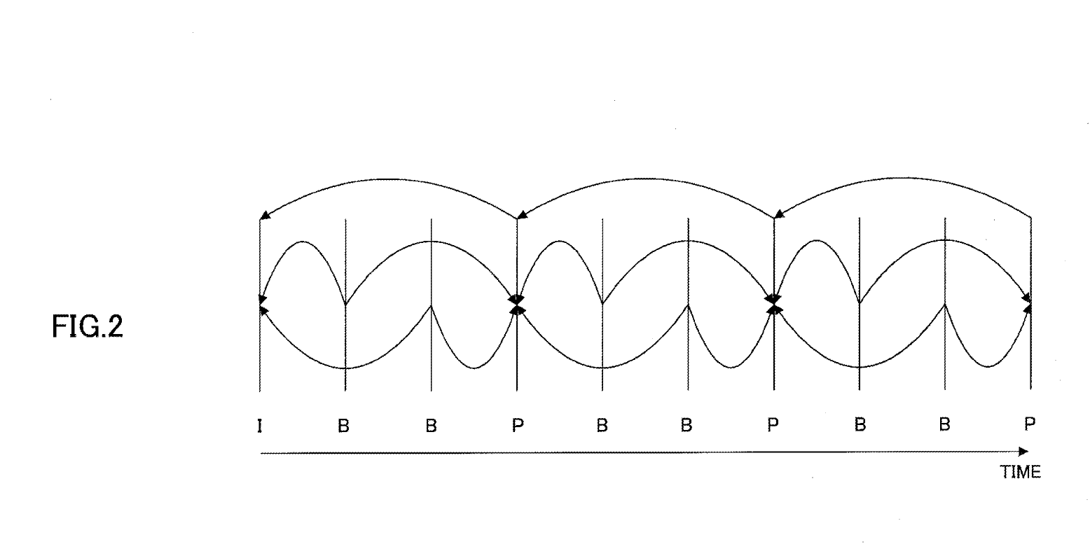

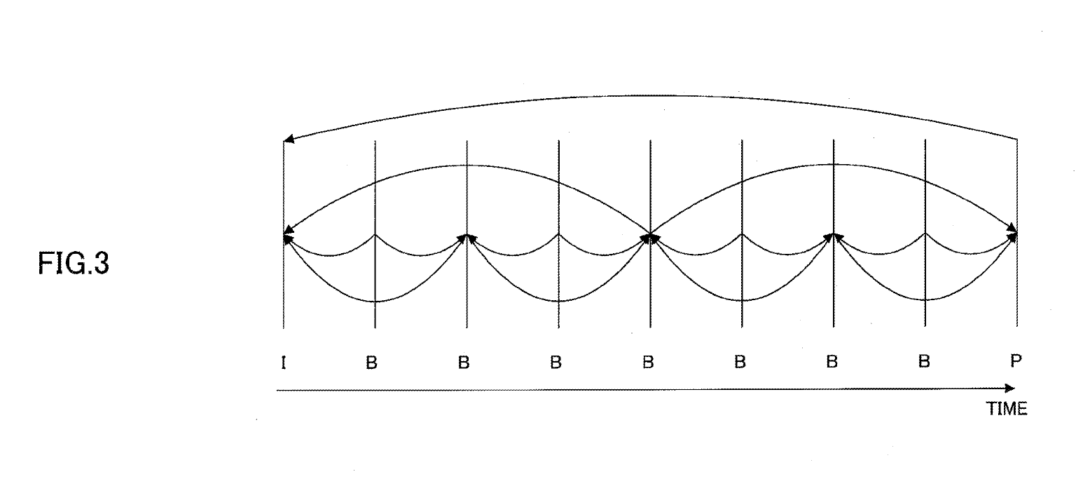

### DESCRIPTION OF EMBODIMENTS

Preferred embodiments of the present invention will be explained with reference to accompanying drawings.

### First Embodiment

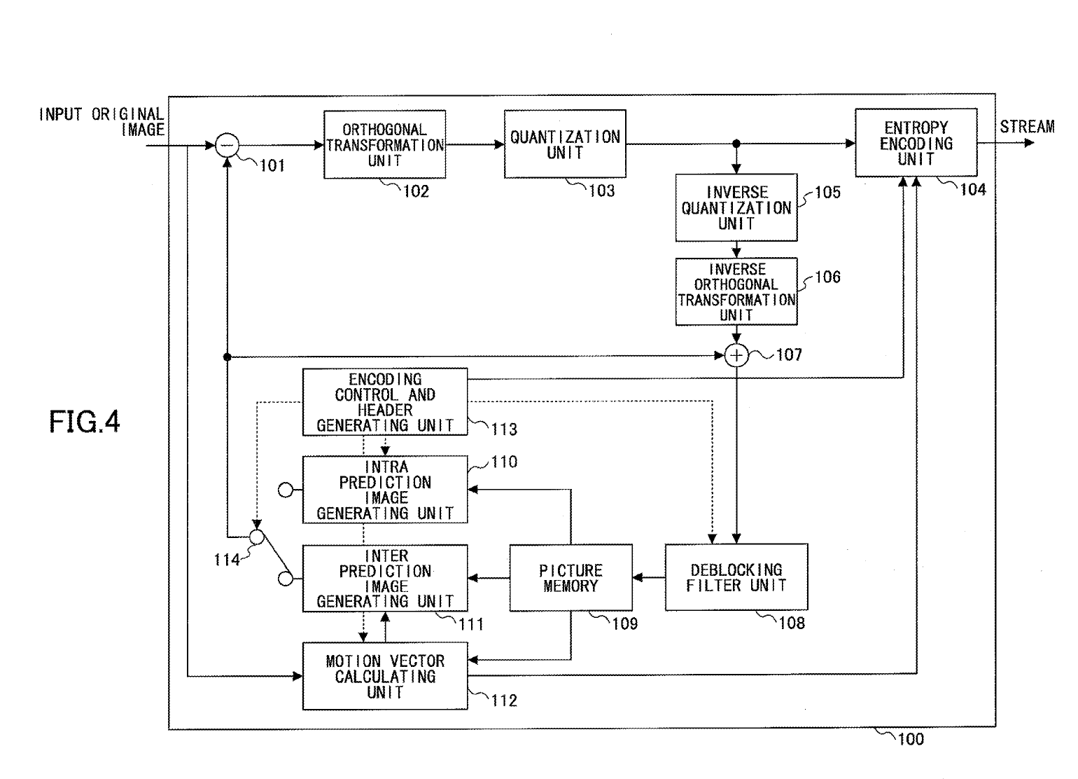

FIG. 4 is a block diagram of an image encoding device 100 according to a first embodiment. As illustrated in FIG. 4, the image encoding device 100 according to the first embodiment includes a prediction error signal generating unit 101, an orthogonal transformation unit 102, a quantization unit 103, an entropy encoding unit 104, an inverse quantization unit 105, an inverse orthogonal transformation unit 106, a decode image generating unit 107, a deblocking filter unit 108, a picture memory 109, an intra prediction image generating unit 110, an inter prediction image generating unit 111, a motion vector calculating unit 112, an encoding control and header generating unit 113, and a prediction image selection unit 114. An outline of each unit is given below.

The prediction error signal generating unit 101 acquires macro block data (hereinafter, also referred to as “block data”) in which an encode target image of input video image data is divided into blocks (hereinafter, also referred to as “macro blocks (MB)”) of 16×16 pixels. The prediction error signal generating unit 101 generates a prediction error signal according to the macro block data described above and the macro block data of a prediction image output from the prediction image selection unit 114. The prediction error signal generating unit 101 outputs the generated prediction error signal to the orthogonal transformation unit 102.

The orthogonal transformation unit 102 performs an orthogonal transformation process on the input prediction error signal. The orthogonal transformation unit 102 outputs a signal that has been divided into frequency components in the horizontal and vertical directions by an orthogonal transformation process, to the quantization unit 103.

The quantization unit 103 quantizes an output signal from the orthogonal transformation unit 102. The quantization unit 103 reduces the encoding amount of the output signal by performing the quantization, and outputs the output signal to the entropy encoding unit 104 and the inverse quantization unit 105.

The entropy encoding unit 104 performs entropy encoding on the output signal from the quantization unit 103, and outputs the output signal. Entropy encoding is a method of assigning variable-length codes according to the appearance frequency of a symbol

The inverse quantization unit 105 performs inverse quantization on the output signal from the quantization unit 103, and outputs the signal to the inverse orthogonal transformation unit 106. The inverse orthogonal transformation unit 106 performs an inverse orthogonal transformation process on the output signal from the inverse quantization unit 105, and outputs the signal to the decode image generating unit 107. As a decoding process is performed by the inverse quantization unit 105 and the inverse orthogonal transformation unit 106, a signal that is approximately the same as the prediction error signal before encoding is obtained.

The decode image generating unit 107 adds together the block data of the image that has undergone motion compensation at the inter prediction image generating unit 111, and the prediction error signal that has undergone a decoding process at the inverse quantization unit 105 and the inverse orthogonal transformation unit 106. The decode image generating unit 107 outputs the block data of the decode image that is generated by the addition, to the deblocking filter unit 108.

The deblocking filter unit 108 applies a filter for reducing block distortion, to the decode image output from the decode image generating unit 107, and outputs the decode image to the picture memory 109.

The picture memory 109 stores the input block data as data of a new reference image, and outputs the data to the intra prediction image generating unit 110, the inter prediction image generating unit 111, and the motion vector calculating unit 112.

The intra prediction image generating unit 110 generates a prediction image from surrounding pixels that have already been encoded, of the encode target image.

The inter prediction image generating unit 111 performs motion compensation with a motion vector provided from the motion vector calculating unit 112, on the data of a reference image acquired from the picture memory 109. Accordingly, block data is generated, as a reference image that has undergone motion compensation.

The motion vector calculating unit 112 obtains a motion vector by using block data in an encode target picture and block data of a reference image that has already been encoded acquired from the picture memory 109. A motion vector is a value indicating spatial displacement in units of blocks, obtained by using a block matching technique of searching a position that is most similar to the encode target image in the reference image in units of blocks. The motion vector calculating unit 112 outputs the obtained motion vector to the inter prediction image generating unit 111.

The block data output from the intra prediction image generating unit 110 and the inter prediction image generating unit 111 is input to the prediction image selection unit 114. The prediction image selection unit 114 selects either one of the prediction images. The selected block data is output to the prediction error signal generating unit 101.

Furthermore, the encoding control and header generating unit 113 implements overall control of encoding and generates a header. The encoding control and header generating unit 113 reports whether there is slice division to the intra prediction image generating unit 110, reports whether there is a deblocking filter to the deblocking filter unit 108, and reports limitation of a reference image to the motion vector calculating unit 112. The encoding control and header generating unit 113 uses the control result to generate, for example, header information of H.264. The generated header information is passed to the entropy encoding unit 104, and is output as a stream together with image data and motion vector data.

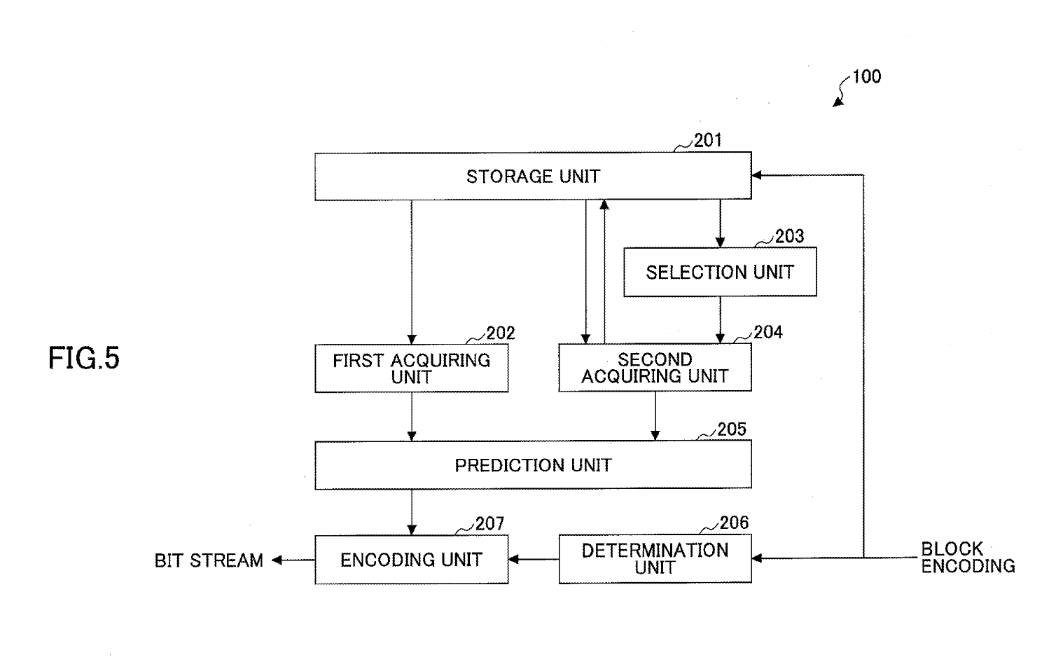

Next, a description is given of functions relevant to prediction of a reference mode. FIG. 5 is a block diagram of functions relevant to prediction of a reference mode according to the first embodiment. As illustrated in FIG. 5, the image encoding device 100 includes a storage unit 201, a first acquiring unit 202, a selection unit 203, a second acquiring unit 204, a prediction unit 205, a determination unit 206, and an encoding unit 207.

The storage unit 201 corresponds to the picture memory 109; the first acquiring unit 202, the selection unit 203, the second acquiring unit 204, the prediction unit 205, and the determination unit 206 correspond to, for example, the motion vector calculating unit 112; and the encoding unit 207 corresponds to the entropy encoding unit 104.

The image encoding device 100 illustrated in FIG. 5 divides the encode target image into plural blocks, and the encode target blocks may refer to decode images of images that have been encoded in plural directions, and the reference mode is encoded. The size of the block may be fixed or may be variable.

The storage unit 201 stores a decode image formed by locally decoding an image that has been encoded, and encode information such as motion vectors in units of blocks, the block type, and the reference mode. The size of the block is, for example, a 16×16 pixel block (macro block). Past encode information may be referred to with an encode target block to be encoded next.

The first acquiring unit 202 acquires, from the storage unit 201, encode information that has been encoded of a block belonging to the encode target image. Block encoding is generally performed in a raster scan order starting from the top left of an encode target image. Therefore, the encode information that has been encoded in the encode target image is all blocks on the left side and top side of the same block line as the encode target block. The first acquiring unit 202 specifies a predetermined block position of an encode target image by a method determined in advance, and acquires encode information that has been encoded belonging to the encode target image from the storage unit 201. The method determined in advance is, for example, determining a block among a block on a top side of the encode target block, a block on a left side of the encode target block, a block on a top left side of the encode target block, and a block on a top right side of the encode target block.

The selection unit 203 selects a reference image by a method determined in advance from plural decode images (reference images) of images that have been encoded, to acquire a reference mode from an image that has been encoded other than the encode target image stored in the storage unit 201. The storage unit 201 may apply unique indices to plural reference images, and store the indices as a list. The selection unit 203 may use a reference image index to indicate a selection result.

The second acquiring unit 204 acquires encode information of a block belonging to a reference image selected at the selection unit 203. The second acquiring unit 204 specifies a block position by a method determined in advance, and acquires, from the storage unit 201, encode information of a block belonging to a reference image having an index selected at the selection unit 203.

The prediction unit 205 calculates a prediction mode that is a prediction value of a reference mode of an encode target block based on encode information obtained from the first acquiring unit 202 and the second acquiring unit 204.

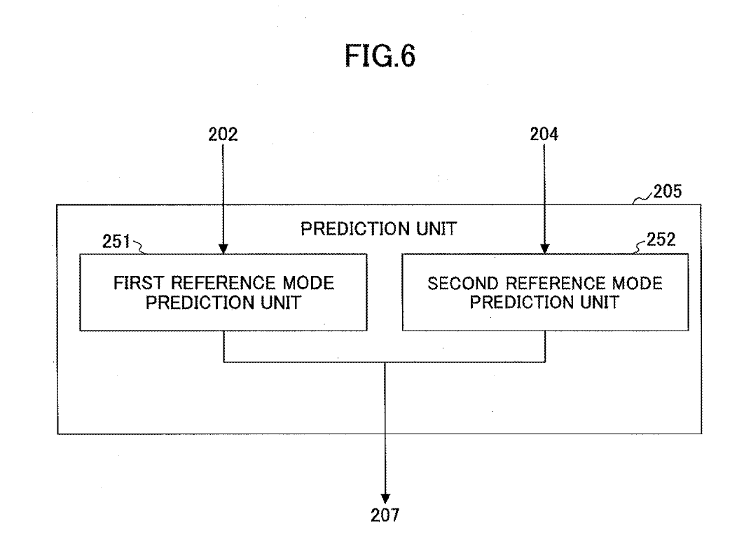

FIG. 6 is a block diagram of functions of the prediction unit 205 according to the first embodiment. As illustrated in FIG. 6, the prediction unit 205 includes a first reference mode prediction unit 251 and a second reference mode prediction unit 252.

The first reference mode prediction unit 251 calculates a candidate mode using encode information acquired from the first acquiring unit 202. The second reference mode prediction unit 252 calculates a candidate mode using encode information acquired from the second acquiring unit 204. The prediction unit 205 determines the prediction mode according to a predetermined standard from among these candidate modes.

Referring back to FIG. 5, the determination unit 206 determines a reference mode used at an encode target block. For example, the determination unit 206 performs block matching between an encode target block and plural reference images, selects the most similar reference image, and determines a reference mode corresponding to the selected reference image.

The encoding unit 207 encodes reference mode information to be sent as a bit stream, which is formed from the prediction mode acquired from the prediction unit 205 and the reference mode determined at the determination unit 206.

Accordingly, by using the first acquiring unit 202 and the second acquiring unit 204, a reference mode of a block that has been encoded and spatially close, and a reference mode of a block that has been encoded and temporally similar, may be acquired. The image encoding device 100 according to the first embodiment determines the prediction mode using these reference modes, so that the prediction precision of the reference mode is increased and the encoding efficiency is improved.

### Second Embodiment

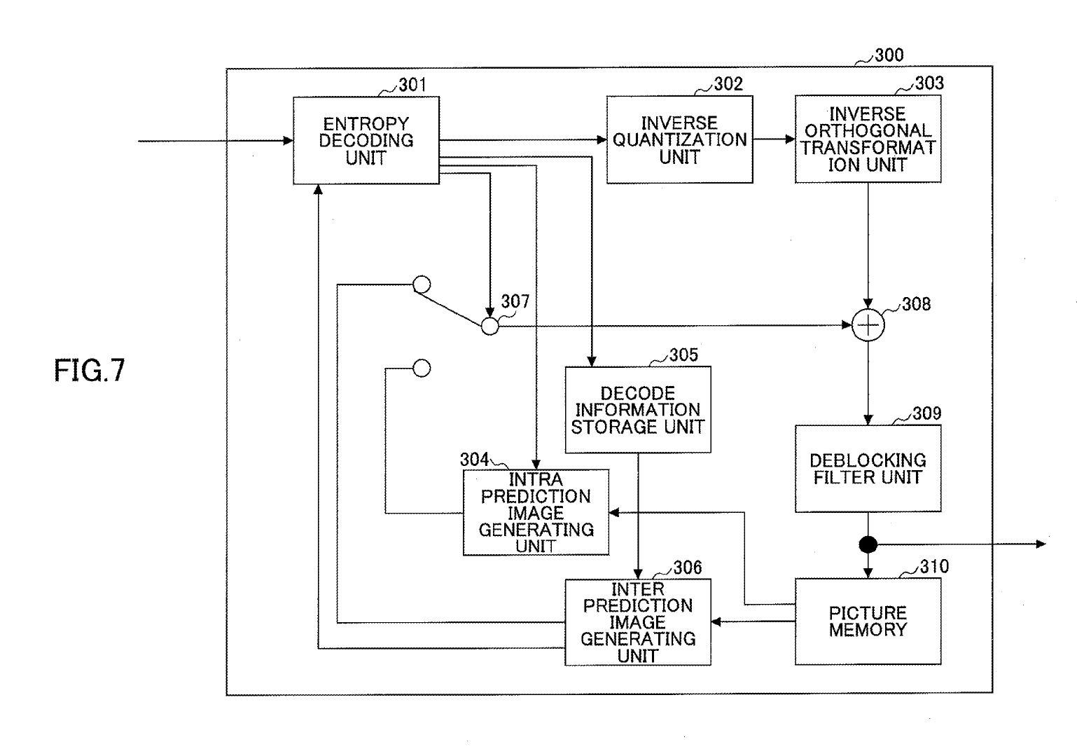

FIG. 7 is a block diagram of an image decoding device 300 according to the second embodiment. The image decoding device 300 according to the second embodiment decodes a bit stream (encoded data) that has been encoded by the image encoding device 100 according to the first embodiment.

As illustrated in FIG. 7, the image decoding device 300 includes an entropy decoding unit 301, an inverse quantization unit 302, an inverse orthogonal transformation unit 303, an intra prediction image generating unit 304, a decode information storage unit 305, an inter prediction image generating unit 306, a prediction image selection unit 307, a decode image generating unit 308, a deblocking filter unit 309, and a picture memory 310. An outline of each unit is given below.

The entropy decoding unit 301 performs entropy decoding corresponding to the entropy encoding of the image encoding device 100, when a bit stream is input. A prediction error signal decoded by the entropy decoding unit 301 is output to the inverse quantization unit 302. When inter prediction is performed, the decoded motion vector is output to the decode information storage unit 305, and when intra prediction is performed, this is reported to the intra prediction image generating unit 304. Furthermore, the entropy decoding unit 301 reports, to the prediction image selection unit 307, whether the decode target image has been inter predicted or intra predicted.

The inverse quantization unit 302 performs an inverse quantization process on the output signal from the entropy decoding unit 301. The output signal that has undergone inverse quantization is output to the inverse orthogonal transformation unit 303.

The inverse orthogonal transformation unit 303 performs an inverse orthogonal transformation process on the output signal from the inverse quantization unit 302, and generates a residual signal. The residual signal is output to the decode image generating unit 308.

The intra prediction image generating unit 304 generates a prediction image from surrounding pixels that have already been decoded of a decode target image acquired from the picture memory 310.

The decode information storage unit 305 stores decode information including a decoded motion vector and reference mode.

The inter prediction image generating unit 306 performs motion compensation on the data of a reference image acquired from the picture memory 310, by using a motion vector and a reference mode acquired from the decode information storage unit 305. Accordingly, block data is generated as a reference image that has undergone motion compensation.

The prediction image selection unit 307 selects either one of an intra prediction image or an inter prediction image. The selected block data is output to the decode image generating unit 308.

The decode image generating unit 308 generates a decode image by adding together the prediction image output from the prediction image selection unit 307 and a residual signal output from the inverse orthogonal transformation unit 303. The generated decode image is output to the deblocking filter unit 309.

The deblocking filter unit 309 applies a filter for reducing block distortion, to the decode image output from the decode image generating unit 308, and outputs the block data to the picture memory 310. The decode image after being filtered may be output to a display device. The picture memory 310 stores the decode image. The decode information storage unit 305 and the picture memory 310 are separate units; however, these elements may be the same storage device.

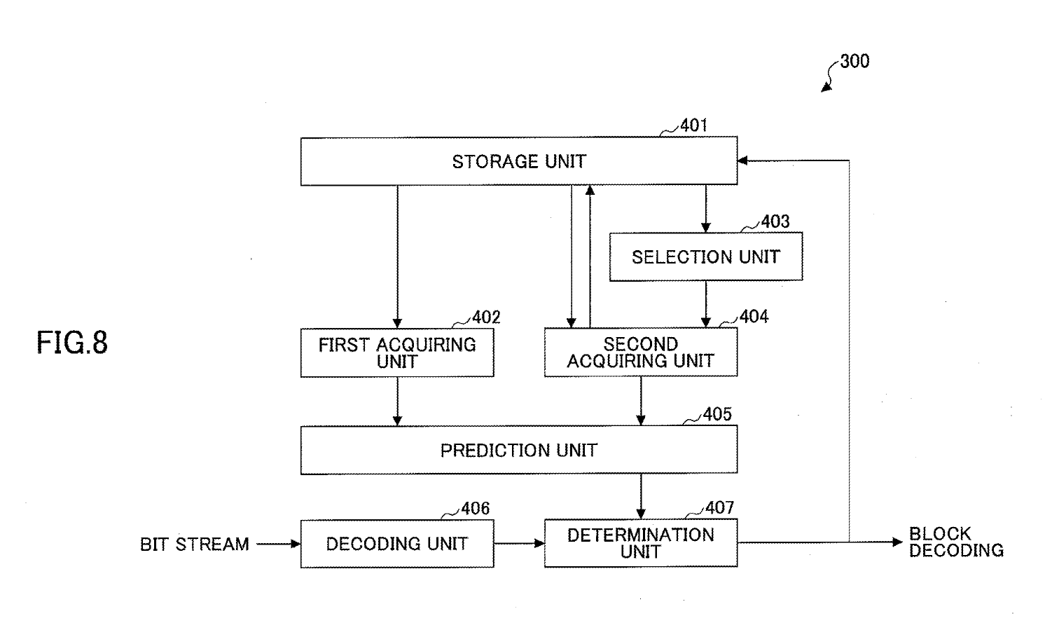

Next, a description is given of functions relevant to prediction of a reference mode. FIG. 8 is a block diagram of functions relevant to prediction of a reference mode according to the second embodiment. As illustrated in FIG. 8, the image decoding device 300 includes a storage unit 401, a first acquiring unit 402, a selection unit 403, a second acquiring unit 404, a prediction unit 405, a decoding unit 406, and a determination unit 407.

The image decoding device 300 illustrated in FIG. 8 decodes a bit stream output from the image encoding device 100, and calculates a reference mode of a decode target block. The respective units of the image decoding device 300 correspond to the storage unit 201, the first acquiring unit 202, the selection unit 203, the second acquiring unit 204, the prediction unit 205, the encoding unit 207, and the determination unit 206 of the image encoding device 100.

The storage unit 401 corresponds to, for example, the decode information storage unit 305 and the picture memory 310; the first acquiring unit 402, the selection unit 403, the second acquiring unit 404, and the prediction unit 405 correspond to, for example, the inter prediction image generating unit 306; and the decoding unit 406 and the determination unit 407 correspond to, for example, the entropy decoding unit 301.

The storage unit 401 stores an image that has been decoded in the past, and decode information such as motion vectors in units of blocks, a block type, and a reference mode.

The first acquiring unit 402 acquires decode information that has been decoded belonging to the decode target image, from the storage unit 401. Block decoding is generally performed in a raster scan order starting from the top left of the decode target image, and therefore the decode information that has been decoded in the decode target image is all blocks on the left side and top side of the same block line as the decode target block.

The selection unit 403 selects an appropriate image that has been decoded from images that have been decoded in plural directions, such that the decode target image is situated between an image that has been decoded and a reference image of the image that has been decoded, in order to obtain decode information from plural images that have been decoded other than the decode target image stored in the storage unit 401.

The second acquiring unit 404 acquires, from the storage unit 401, decode information of a block belonging to an image that has been decoded selected by the selection unit 403.

The prediction unit 405 calculates a prediction mode that is a prediction value of a reference mode of a decode target block, based on decode information obtained from the first acquiring unit 402 and the second acquiring unit 404.

The decoding unit 406 decodes a bit stream and acquires reference mode information used for determining a reference mode.

The determination unit 407 determines a reference mode from the prediction mode acquired from the prediction unit 405 and the reference mode information acquired from the decoding unit 406. The determined reference mode is output to and stored in the storage unit 401.

Accordingly, by using the first acquiring unit 402 and the second acquiring unit 404, it is possible to acquire a reference mode of a block that has been decoded and that is spatially close, and a reference mode of a block that has been decoded in the temporal direction. The image decoding device 300 according to the second embodiment uses these reference modes to handle encoded data in which the prediction precision of the reference mode is increased, so that the decode efficiency is improved.

### Third Embodiment

Next, a description is given of an image encoding device according to a third embodiment. The configuration of the image encoding device according to the third embodiment is the same as the configuration illustrated in FIG. 4. Functions relevant to prediction of a reference mode of the image encoding device according to the third embodiment are described by using the same reference numerals of the functions illustrated in FIG. 5.

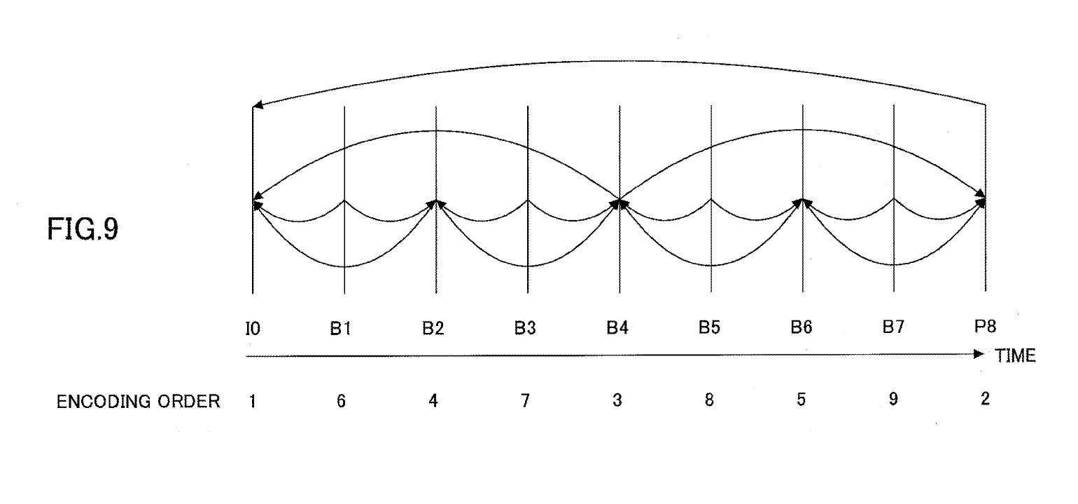

A description is given of a GOP configuration used in the following embodiments. FIG. 9 illustrates a GOP configuration used in the embodiments. In the example of FIG. 9, I, P, and B express a picture type, and numbers adjacent to I, P, and B express the time order. Furthermore, the encoding order is I0, P8, B4, B2, B6, B1, B3, B5, B7. The arrows in FIG. 9 are vectors in the forward direction or the backward direction.

In the third embodiment, a case of encoding a B6 picture is taken as an example. When encoding a B6 picture, the B4 picture and the P8 picture have already been encoded, so that it is already possible to refer to the B4 picture and the P8 picture as images that have been encoded at the time of encoding the B6 picture.

The storage unit 201 stores encode information of images RPs (Reference Picture group) that have been encoded. For example, the storage unit 201 stores encode information relevant to the B4 picture and the P8 picture, such as motion vectors in units of blocks, the block type, and the reference mode.

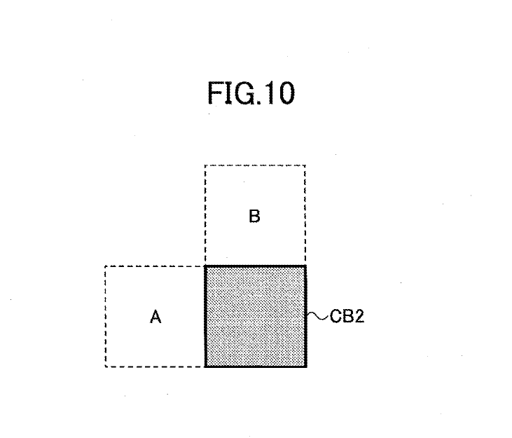

The first acquiring unit 202 acquires encode information of a block that has been encoded belonging to an encode target image CP (Coding Picture). FIG. 10 illustrates the relationship between an encode target block and surrounding blocks (part 1). For example, as illustrated in FIG. 10, it is assumed that the reference modes of a left block A and a top block B adjacent to an encode target block CB2 are reference modes A and B, respectively.

The first acquiring unit 202 acquires the respective reference modes A and B of the left block A and the top block B from the storage unit 201. Furthermore, the first acquiring unit 202 may also acquire the reference modes of the top left block and the top right block adjacent to CB2. Furthermore, in an encoding method as H.264 where the reference mode is defined as a block type, the first acquiring unit 202 may acquire the block type. When block A and block B have been intra encoded, the first acquiring unit 202 sets the reference mode as invalid. The first acquiring unit 202 outputs the acquired reference modes A and B to the prediction unit 405. Here, it is assumed that the reference mode of block A of the B6 picture is reference mode A, and the reference mode of block B of the B6 picture is reference mode B.

The selection unit 403 selects an image that has been encoded such that the encode target image is situated between an image that has been encoded and a reference image of the image that has been encoded. For example, as illustrated in FIG. 9, the B4 picture refers to the P8 picture, and the P8 picture refers to the I0 picture. Furthermore, the B6 picture that is an encode target is situated between the B4 picture and the P8 picture, and between the I0 picture and the P8 picture. Thus, there are plural encode target images situated between an image that has been encoded and a reference image of the image that has been encoded.

The selection unit 203 preferably selects an image that has been encoded having the smallest interval between the image that has been encoded and the reference image of the image that has been encoded, because the smaller the interval between an image that has been encoded and a reference image of the image that has been encoded, the higher the reliability of the prediction.

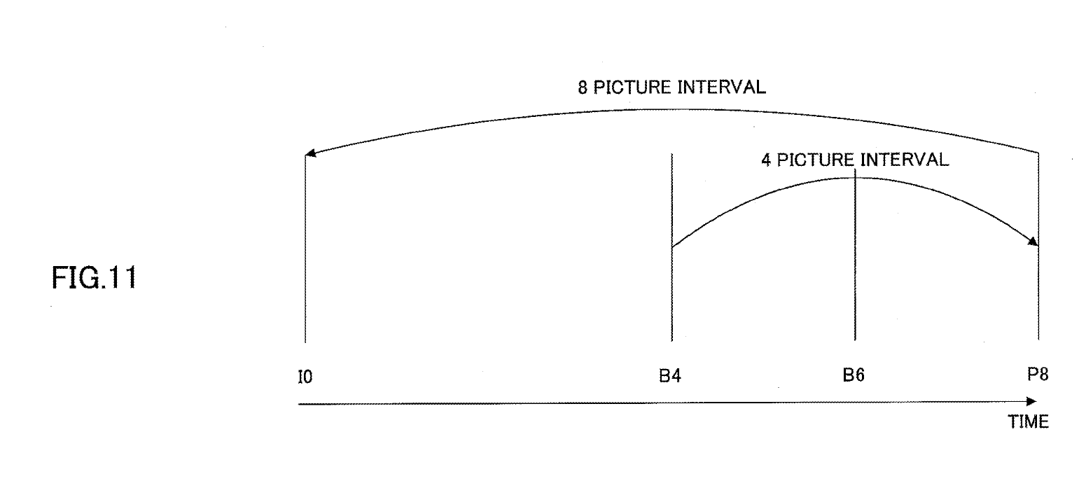

FIG. 11 is for describing the interval between an image that has been encoded and a reference image of the image that has been encoded. As illustrated in FIG. 11, there is a four picture interval between the B4 picture and the P8 picture, and there is an eight picture interval between the I0 picture and the P8 picture. Therefore, the selection unit 203 selects the B4 picture.

The second acquiring unit 204 acquires, from the storage unit 201, encode information of a block belonging to a decode image of an image that has been encoded selected by the selection unit 203. The second acquiring unit 204 preferably determines in advance, the block from which the encode information is to be acquired, in the decode image in the selected image that has been encoded.

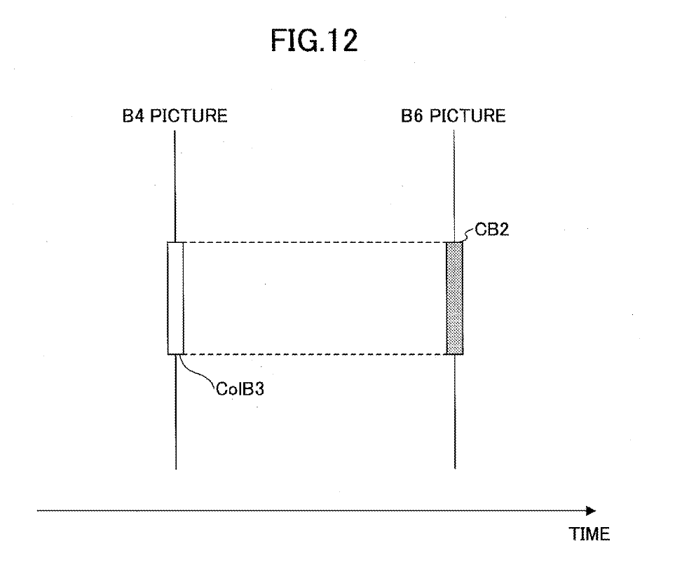

FIG. 12 illustrates a block located at the same position as the encode target block. For example, as illustrated in FIG. 12, the second acquiring unit 204 acquires a reference mode X of a block ColB3 (Collocated block X) that is at the same position as the encode target block CB2 in the B4 picture. Furthermore, the second acquiring unit 204 may acquire a macro block type including the reference mode. The second acquiring unit 204 outputs the acquired reference mode X to the prediction unit 205.

The prediction unit 205 calculates the prediction mode that is a prediction value of a reference mode of an encode target block, based on the encode information acquired from the first acquiring unit 202 and the second acquiring unit 204. The prediction unit 205 includes a first reference mode prediction unit 251 and a second reference mode prediction unit 252.

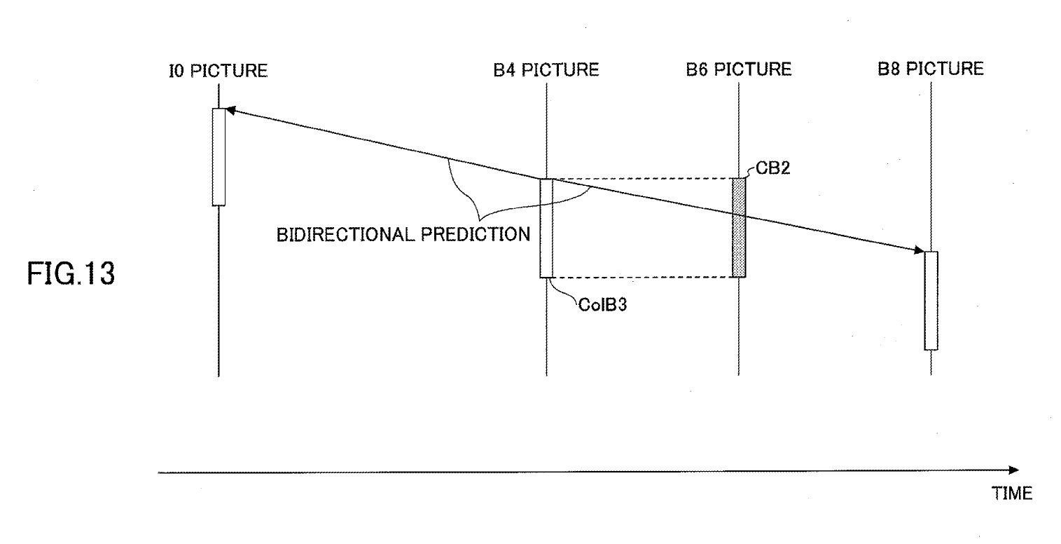

The first reference mode prediction unit 251 sets the reference mode A in the B6 picture acquired from the storage unit 201 as candidate mode A, and sets the reference mode B in the B6 picture acquired from the storage unit 201 as candidate mode B. FIG. 13 illustrates a process performed by the second reference mode prediction unit 252 according to the third embodiment. As illustrated in FIG. 13, it is assumed that the second reference mode prediction unit 252 has determined that the reference mode X of the block ColB3 acquired from the second acquiring unit 204 includes a reference in the B6 picture direction from the B4 picture. That is to say, it is assumed that the second reference mode prediction unit 252 has determined that the reference mode X includes a reference to the P8 picture (backward direction or two-way direction (bidirectional)).

In this case, it is considered that an area similar to the encode target block is present in both the B4 picture and the P8 picture. Therefore, the second reference mode prediction unit 252 sets bidirectional as the candidate mode X. Furthermore, when the reference mode X obtained by the second acquiring unit 204 is the forward direction, or invalid, i.e., intra encoding, the second reference mode prediction unit 252 sets the candidate mode X as invalid.

The prediction unit 205 sets, as the prediction mode, the most frequent reference mode among the candidate modes A, B, and X. When all candidate modes are different, the candidate mode X is set as the prediction mode. Furthermore, when all candidate modes are intra encoded, and the reference mode is invalid, the prediction unit 205 sets bidirectional as the prediction mode.

The determination unit 206 performs block matching between the encode target block and the plural reference images, selects the most similar reference image, and determines the reference mode of the selected reference image as the encoding mode. The evaluation value of block matching may be the pixel sum of absolute differences, or the pixel sum of squared differences.

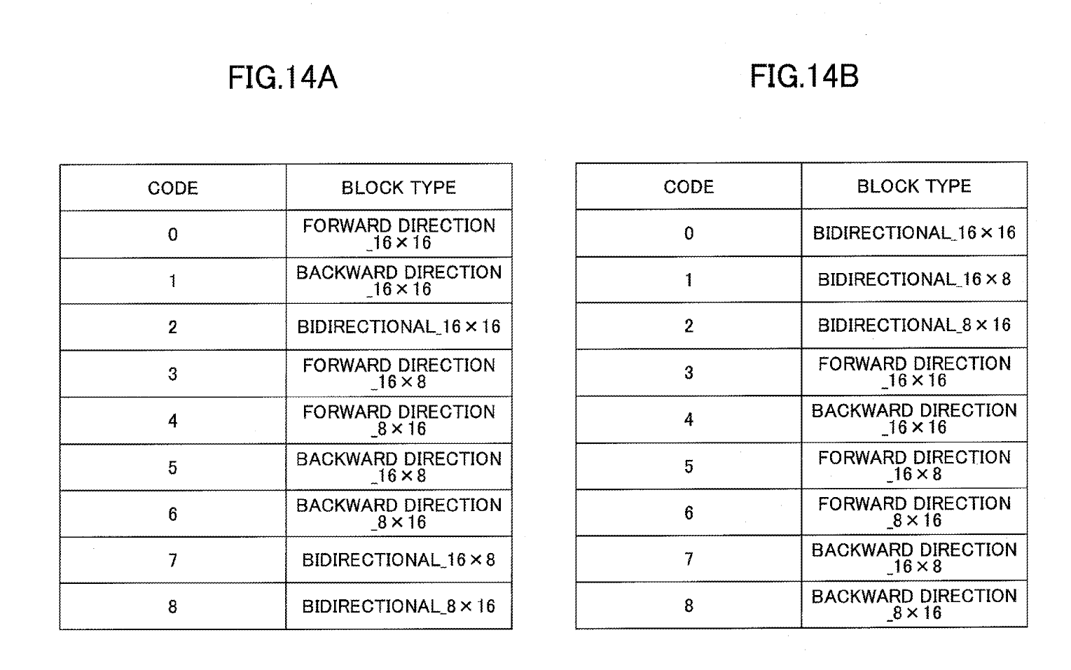

The encoding unit 207 is described by taking as an example the reference mode encoding method of H.264. FIGS. 14A and 14B illustrate the reference mode and the division mode being encoded as a block type. As illustrated in FIGS. 14A and 14B, the encoding unit 207 encodes the reference mode as a block type together with a division type. The division type expresses a block size such as 16×16.

Here, it is assumed that the lower the encoding value, the smaller the encoding amount. In this case, as illustrated in FIG. 14A, the encoding values set in advance are allocated in the order of the division type, which is not efficient. In the third embodiment, the encoding table is changed based on the reference mode. That is to say, the encoding unit 207 appropriately changes the encoding table so that the encoding amount of a block including a prediction mode is small. For example, when the prediction mode is bidirectional, the encoding unit 207 moves up the rank order of macro block types including bidirectional as illustrated in FIG. 14B, and assigns low encoding values to these macro block types.

Accordingly, if the prediction mode of bidirectional matches the actual reference mode, encoding may be performed by a low encoding value, so that the encoding amount is reduced.

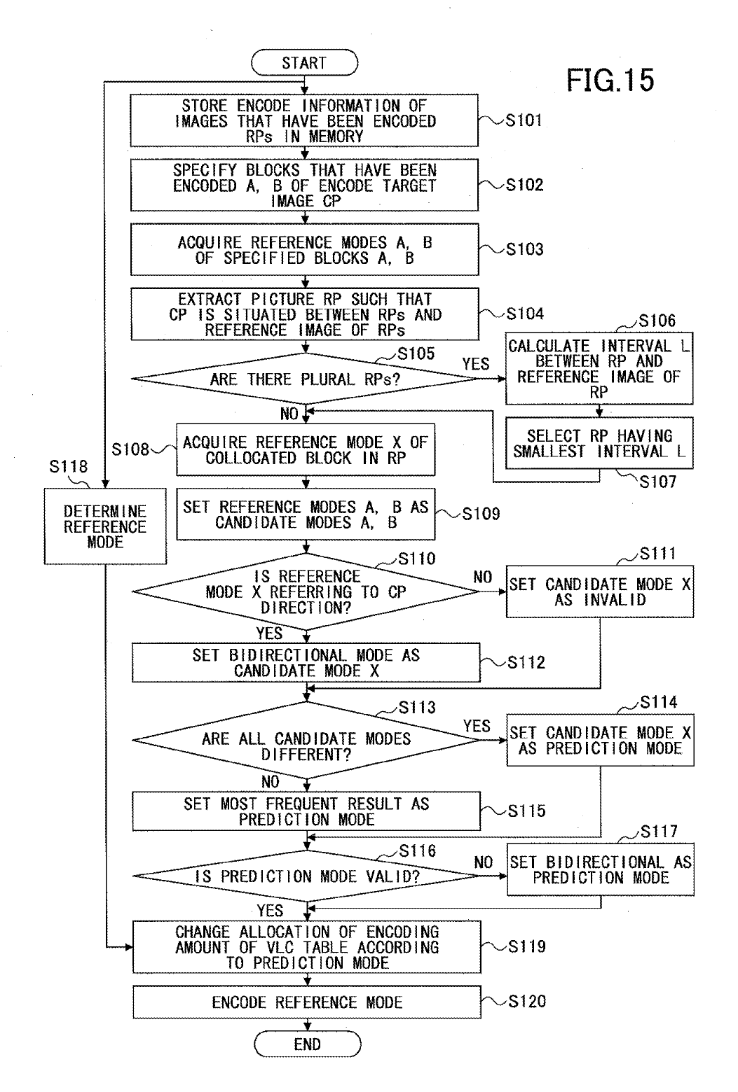

Next, a description is given of an operation of the image encoding device according to the third embodiment. FIG. 15 is a flowchart of a reference mode encoding process according to the third embodiment.

In step S101 of FIG. 15, the storage unit 201 stores encode information of images that have been encoded RPs (Reference Picture group), such as a motion vector in units of blocks, a block type, and a reference mode.

In steps S102 and S103, the first acquiring unit 202 acquires encode information of a block that has been encoded belonging to an encode target image CP (Coding Picture), from the storage unit 201. In the example of FIG. 10, the first acquiring unit 202 acquires the reference modes A and B of the left block A and the top block B, respectively. When the block A and block B have been intra encoded, the first acquiring unit 202 sets the reference modes as invalid.

In step S104, the selection unit 203 selects an image RP (Reference Picture) that has been encoded, such that the encode target image is situated between an image that has been encoded and a reference image of the image that has been encoded.

In step S105, the selection unit 203 determines whether there is a plurality of the acquired RPs. When there is a plurality of the acquired RPs (YES in step S105), the process proceeds to step S106, and when there is not a plurality of the acquired RPs (NO in step S105), the process proceeds to step S108.

In steps S106 and S107, the selection unit 203 calculates an interval L between the image that has been encoded and the reference image of the image that has been encoded, and selects an image RP that has been encoded having the smallest interval L.

In step S108, the second acquiring unit 204 acquires, from the storage unit 201, a reference mode X of a Collocated block belonging in a decode image of an image that has been encoded selected by the selection unit 203.

In step S109, the first reference mode prediction unit 251 sets the reference modes A and B as candidate modes A and B, respectively.

In step S110, the second reference mode prediction unit 252 determines whether the reference mode X is referring to the CP direction. With reference to the example of FIG. 13, the second reference mode prediction unit 252 determines whether the reference mode X is referring to a two-way direction (bidirectional) or backward direction. When the reference mode is referring to the CP direction (YES in step S110), the process proceeds to step S112, and when the reference mode is not referring to the CP direction (NO in step S110), the process proceeds to step S111.

In step S111, the second reference mode prediction unit 252 sets the candidate mode X as invalid.

In step S112, the second reference mode prediction unit 252 sets the bidirectional mode as the candidate mode X.

In step S113, the prediction unit 205 sets the most frequent reference mode among the candidate modes A, B, and X as the prediction mode. Therefore, for example, the prediction unit 205 determines whether all candidate modes are different. When all candidate modes are different (YES in step S113), the process proceeds to step S114, and when all candidate modes are not different (NO in step S113), the process proceeds to step S115.

In step S114, the prediction unit 205 sets the candidate mode X as the prediction mode. In step S115, the prediction unit 205 sets the most frequent reference mode among the candidate modes A, B, and X as the prediction mode.

In step S116, the prediction unit 205 determines whether the prediction mode is valid. When the prediction mode is valid (YES in step S116), the process proceeds to step S119, and when the prediction mode is invalid (NO in step S116), the process proceeds to step S117.

In step S117, the prediction unit 205 sets bidirectional as the prediction mode.

In step S118, the determination unit 206 determines the reference mode of the encode target block by block matching.

In step S119, the encoding unit 207 changes the allocated encoding amount in the VLC (variable length encoding) table according to the prediction mode. For example, when the prediction mode is indicating bidirectional, the encoding unit 207 changes the encoding table illustrated in FIG. 14A to the encoding table illustrated in FIG. 14B.

In step S120, the encoding unit 207 uses the changed VLC table to encode the reference mode of the encode target block. The process of FIG. 15 is performed for each encode target block of a B picture.

The reference mode of a Collocated block may be a direct mode. In this case, the reference mode may be invalid, or the reference mode may be determined according to a motion vector of an anchor block that is actually used. For example, when the Collocated block uses a bidirectional motion vector according to a direct mode, the reference mode of the Collocated block is set as bidirectional.

As described above, according to the third embodiment, it is possible to acquire a reference mode of a block that has been encoded that is spatially close, and a reference mode of a decode block of a block that has been encoded at the same position as an encode target block in the temporal direction. Accordingly, the prediction precision of the reference mode of the encode target block is increased. This is based on the concept of searching for blocks that are similar to the encode target block in spatial and temporal viewpoints, and using the most frequently used reference mode of the blocks estimated as similar, as the reference mode of the encode target block. If the prediction precision of the reference mode increases, the encoding may be performed by a small encoding amount, and therefore the encoding efficiency is improved.

### Fourth Embodiment

Next, a description is given of an image decoding device according to a fourth embodiment. The configuration of the image decoding device according to the fourth embodiment is the same as that illustrated in FIG. 7. Furthermore, functions relevant to prediction of the reference mode of the image decoding device according to the fourth embodiment are described by using the same reference numerals of the functions indicated in FIG. 8.

Furthermore, the image decoding device according to the fourth embodiment decodes a bit stream that has been encoded by the image encoding device according to the third embodiment.

The storage unit 401 stores image DRPs (Decoded Reference Picture group) that have been decoded in the past, and decode information such as motion vectors in units of blocks, a block type, and a reference mode.

The first acquiring unit 402 acquires decode information that has been decoded belonging to the decode target image DP (Decoding Picture), from the storage unit 401. Here, the reference mode A of the right block A of the decode target block and the reference mode B of the top block B of the decode target block in the same screen are acquired.

The selection unit 403 selects a predetermined image that has been decoded from a plurality of images that have been decoded other than the decode target image stored in the storage unit 401. For example, the selection unit 403 selects an appropriate image DRP that has been decoded from images that have been decoded in plural directions such that the decode target image is situated between an image that has been decoded and a reference image of the image that has been decoded.

The second acquiring unit 404 acquires, from the storage unit 401, a reference mode X of a Collocated block of the image DRP that has been decoded selected by the selection unit 403.

The prediction unit 405 calculates a prediction mode that is a prediction value of a reference mode of a decode target block, based on the reference modes A and B acquired from the first acquiring unit 402 and the reference mode X acquired from the second acquiring unit 404. In this case, according to decision by a majority, the most frequent reference mode is set as the prediction mode.

The decoding unit 406 decodes reference mode information used for determining a reference mode from a bit stream. In this case, as the reference mode information, codes converted using the VLC table are decoded and acquired.

The determination unit 407 changes the VLD (variable length decoding) table based on the prediction mode acquired from the prediction unit 405. In this case, the determination unit 407 changes the VLD table so that a code of a macro block type including a prediction mode becomes a low value. The determination unit 407 determines the reference mode from the reference mode information acquired from the decoding unit 406 and the changed VLD table. The determined reference mode is output to and stored in the storage unit 401.

Accordingly, the bit stream generated by the image encoding device described with reference to the third embodiment is decoded.

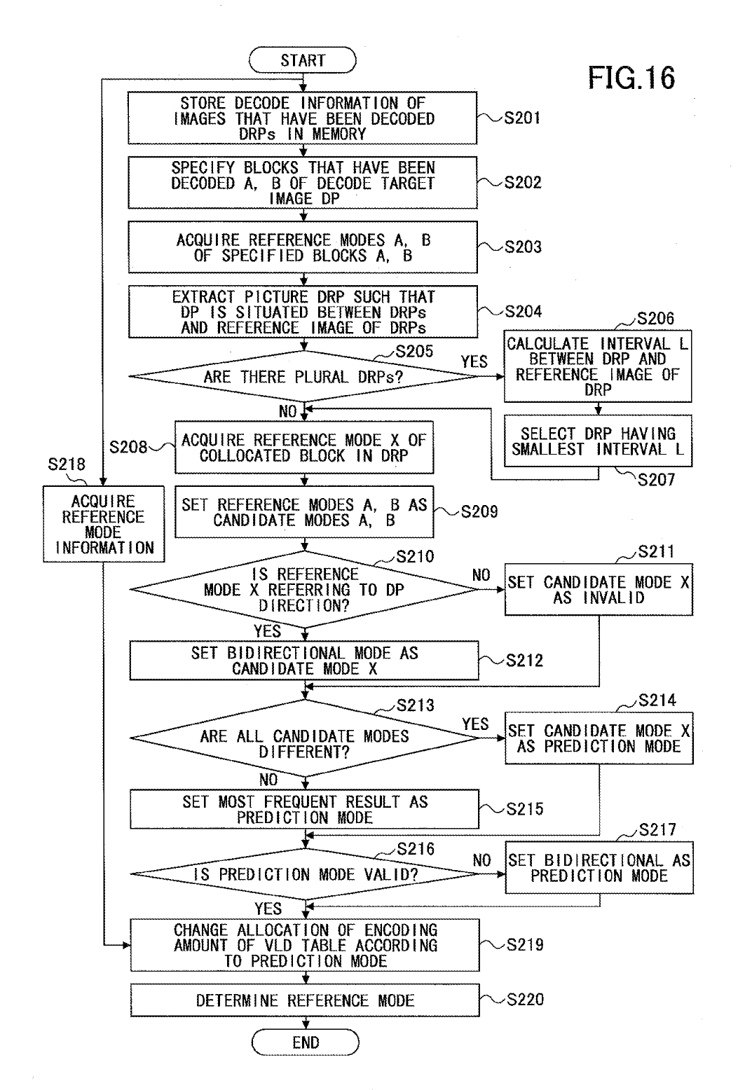

Next, a description is given of an operation of the image decoding device according to the fourth embodiment. FIG. 16 is a flowchart of a reference mode decoding process according to the fourth embodiment.

In step S201 of FIG. 16, the storage unit 401 stores decode information of images that have been decoded DRPs, such as a motion vector in units of blocks, a block type, and a reference mode.

In steps S202 and S203, the first acquiring unit 402 acquires decode information of a block that has been decoded belonging to a decode target image DP, from the storage unit 401. In the example of FIG. 10, the first acquiring unit 402 acquires, from the storage unit 401, the reference modes A and B of the left block A and the top block B, respectively. When the block A and block B have been intra encoded, the first acquiring unit 402 sets the reference modes as invalid.

In step S204, the selection unit 403 selects an image DRP that has been decoded, such that the decode target image DP is situated between an image DRP that has been decoded and a reference image of the image that has been decoded DRP.

In step S205, the selection unit 403 determines whether there is a plurality of the acquired DRPs. When there is a plurality of the acquired DRPs (YES in step S205), the process proceeds to step S206, and when there is not a plurality of the acquired DRPs (NO in step S205), the process proceeds to step S208.

In steps S206 and S207, the selection unit 403 calculates an interval L between an image that has been decoded and a reference image of the image that has been decoded, and selects the image DRP that has been decoded having the smallest interval L.

In step S208, the second acquiring unit 404 acquires, from the storage unit 401, a reference mode X of a Collocated block of the image that has been decoded selected by the selection unit 403.

In step S209, the prediction unit 405 sets the reference modes A and B as candidate modes A and B, respectively.

In step S210, the prediction unit 405 determines whether the reference mode X is referring to the DP direction. When the reference mode X is referring to the DP direction (YES in step S210), the process proceeds to step S212, and when the reference mode X is not referring to the DP direction (NO in step S210), the process proceeds to step S211.

In step S211, the prediction unit 405 sets the candidate mode X as invalid. In step S212, the prediction unit 405 sets the bidirectional mode as the candidate mode X.

In step S213, the prediction unit 405 sets the most frequent reference mode among candidate modes A, B, and X as the prediction mode, and therefore, for example, the prediction unit 405 determines whether all candidate modes are different. When all candidate modes are different (YES in step S213), the process proceeds to step S214, and when all candidate modes are not different (NO in step S213), the process proceeds to step S215.

In step S214, the prediction unit 405 sets the candidate mode X as the prediction mode. In step S215, the prediction unit 405 sets the most frequent reference mode among the candidate modes A, B, and X as the prediction mode.

In step S216, the prediction unit 405 determines whether the prediction mode is valid. When the prediction mode is valid (YES in step S216), the process proceeds to step S219, and when the prediction mode is invalid (NO in step S216), the process proceeds to step S217.

In step S217, the prediction unit 405 sets bidirectional as the prediction mode. In step S218, the decoding unit 406 decodes the bit stream, and acquires the reference mode information of the decode target block. The reference mode information expresses the codes of the VLC table.

In step S219, the determination unit 407 changes the allocated encoding amount in the VLD table according to the prediction mode.

In step S220, the determination unit 407 uses the VLD table that has been changed by using the prediction mode, and the reference mode information, to determine the reference mode of the decode target block. The process of FIG. 16 is performed for each decode target block in the B picture.

As described above, according to the fourth embodiment, it is possible to acquire a reference mode of a block that has been decoded that is spatially close, and a reference mode of a block that has been decoded at the same position as a decode target block in the temporal direction. Accordingly, it is possible to determine the reference mode of the decode target block in accordance with the encoding operation in which the prediction precision of the reference mode is increased.

### Fifth Embodiment

Next, a description is given of an image encoding device according to a fifth embodiment. The configuration of the image encoding device according to the fifth embodiment is the same as the configuration illustrated in FIG. 4. Functions relevant to prediction of a reference mode by the image encoding device according to the fifth embodiment are described by using the same reference numerals of the functions illustrated in FIG. 5.

In the fifth embodiment, the prediction method of a reference mode is described by using the B6 picture indicated in FIG. 9 as the encode target image. The storage unit 201 is the same as that of the third embodiment.

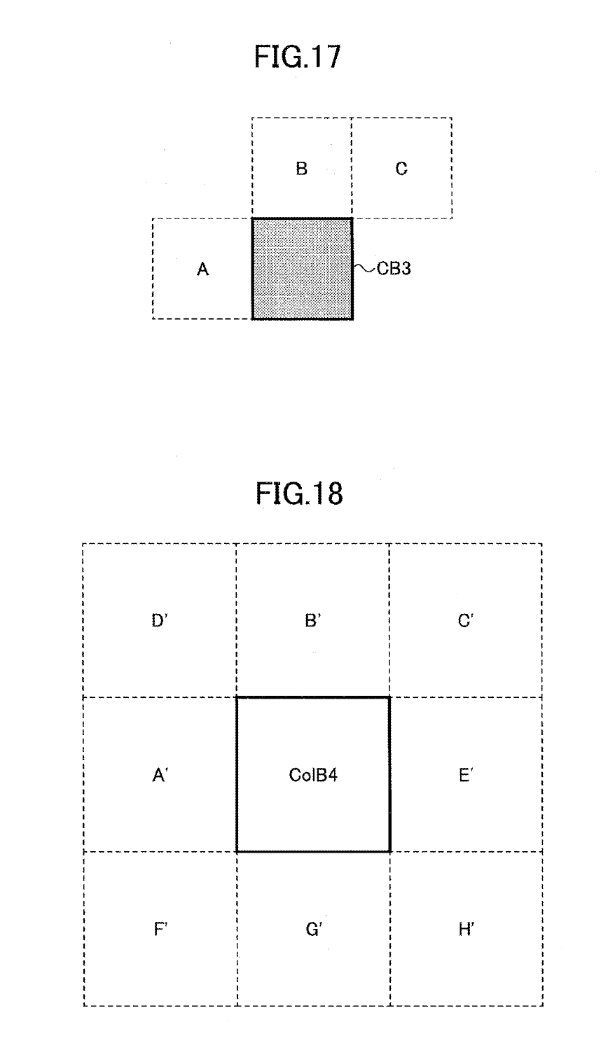

As illustrated in FIG. 17, the first acquiring unit 202 acquires the respective reference modes A, B, and C of the left block A, the top block B, and the top right block C of the encode target block CB3. FIG. 17 illustrates the relationship between an encode target block and surrounding blocks (part 2). For example, as illustrated in FIG. 17, the reference modes of the left block A, the top block B, and the top right block C adjacent to the encode target block CB3 are set as reference modes A, B, and C, respectively.

A description is given of a selection process by the selection unit 203. Here, it is assumed that there are plural images that have been encoded such that an encode target image is situated between an image that has been encoded and a reference image of the image that has been encoded, and that there are images that have been encoded that sandwich an encode target image. In this case, the selection unit 203 selects a pair of two pictures in which the interval between an image that has been encoded and the reference image of the image that has been encoded is small.

In the example of FIG. 9, the B4 picture and the P8 picture are images that have been encoded such that an encode target image is situated between an image that has been encoded and a reference image of the image that has been encoded. Furthermore, a pair of the B4 picture and the P8 picture is selected because the B4 picture and the P8 picture are images that have been encoded that sandwich the encode target image B6 picture.

The second acquiring unit 204 first acquires, from the storage unit 201, a Collocated block ColB4 at the same position as the encode target block in the B4 picture and blocks surrounding the Collocated block ColB4. FIG. 18 illustrates an example of the relationship between the Collocated block and surrounding blocks.

As illustrated in FIG. 18, the second acquiring unit 204 acquires motion vectors of blocks A′ through H′ of the B4 picture to the P8 picture. Information of all images that have been encoded may be used, and therefore, the area for acquiring encode information may be an area that is specified in advance. For example, a specified area may be the Collocated block ColB4, the block A′, and the block B′, or all blocks in the B4 picture. Furthermore, as for the P8 picture, the motion vectors to the I0 picture are similarly acquired.

The first reference mode prediction unit 251 sets the reference modes A, B, and C in the B6 picture acquired from the first acquiring unit 202, as candidate modes A, B, and C, respectively.

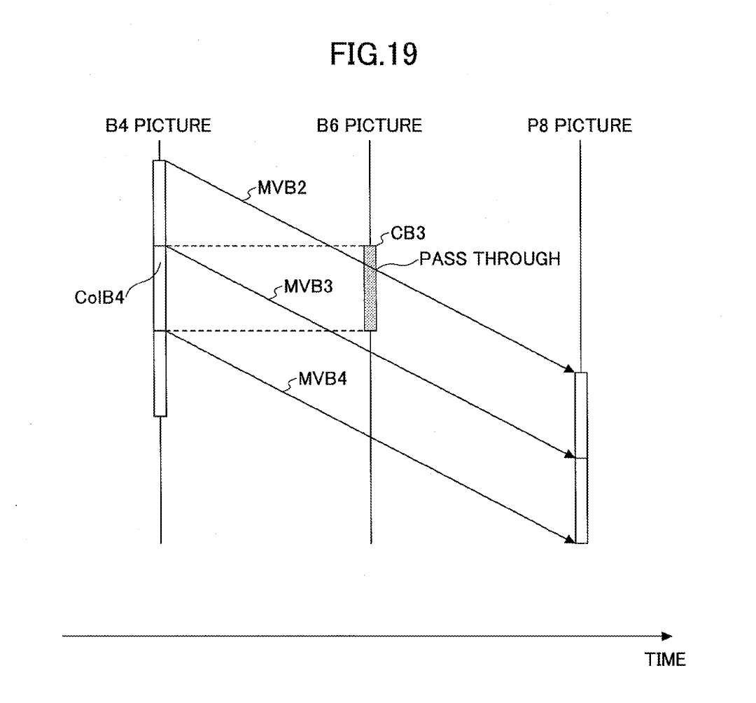

FIG. 19 illustrates a process performed by the second reference mode prediction unit 252 according to the fifth embodiment. As illustrated in FIG. 19, the second reference mode prediction unit 252 determines whether there is at least one motion vector that passes through the encode target block CB3, among the motion vectors (MVB2 through MVB4) from the B4 picture to the P8 picture and the motion vectors from the P8 picture to the I0 picture, which have been acquired from the second acquiring unit 204.

When a motion vector MVB2 passing the encode target block CB3 is detected, the second reference mode prediction unit 252 determines that an area similar to the encode target block CB3 is included in both the B4 picture and the P8 picture.

Furthermore, in the case of a motion vector from the P8 picture to the I0 picture, there is a B4 picture between the P8 picture and the I0 picture. Accordingly, the second reference mode prediction unit 252 determines that there is an area similar to the encode target block CB3 included in both the B4 picture and the P8 picture.

When it is determined that there is an area similar to CB3 included in the B4 picture and the P8 picture, the second reference mode prediction unit 252 sets bidirectional as the candidate mode X. When there is no motion vector passing through the encode target block CB3, the second reference mode prediction unit 252 sets the candidate mode X as invalid.

The prediction unit 205 sets the candidate mode X as the prediction mode if the candidate mode X is valid. If the candidate mode X is invalid, the prediction unit 205 sets the most frequent mode among the candidate modes A, B, and C as the prediction mode. When all candidate modes are different, and all candidate modes are invalid, for example, bidirectional is set as the prediction mode.

The determination unit 206 performs block matching on the encode target block and the plural reference images, selects the most similar reference image, and sets the reference mode of the selected image as the encoding mode.

The encoding unit 207 calculates a flag indicating whether the prediction mode acquired from the prediction unit 205 and the reference mode determined by the determination unit 206 match, and when the prediction mode acquired from the prediction unit 205 and the reference mode determined by the determination unit 206 do not match, the encoding unit 207 encodes the information of selecting the remaining two modes.

For example, when the above calculation result indicates “matching”, the encoding unit 207 sets the mismatch flag as “0”, and when the calculation result indicates “mismatching”, the encoding unit 207 sets the mismatch flag as “1”. Furthermore, after the mismatch flag “1”, the encoding unit 207 sets information of 1 bit indicating either a forward direction or a backward direction.

When the encoding unit 207 uses arithmetic encoding, for example, the encoding unit 207 may reduce the encoding amount by increasing the probability of symbol 0. That is to say, by increasing the prediction precision of the prediction mode, the frequency that the mismatching flag becomes “0” increases, and the encoding efficiency may be improved in arithmetic encoding. As to a symbol after “1” of the mismatch flag indicating mismatching, a prediction order is further applied according to the number of modes that have become candidate modes and the number of forward direction motion vectors and backward direction motion vectors. In this example, the frequency of the symbol “0” is to be increased, and therefore the second most frequent mode among the candidate modes may be “0” and the third most frequent mode may be “1”.

For example, it is assumed that the prediction mode and the reference mode do not match, but a “forward direction” mode is the second most frequent mode among the candidate modes. In this case, the mismatch flag indicating the reference mode in the forward direction is “10”, and the mismatch flag indicating the reference mode in the backward direction is “11”.

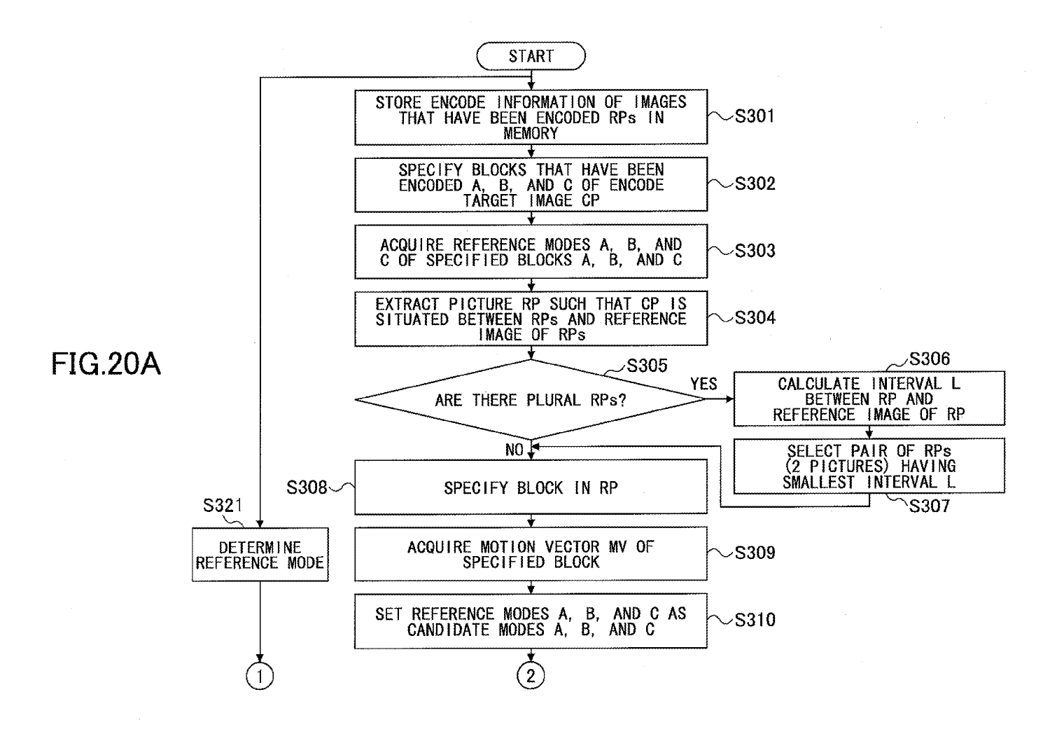

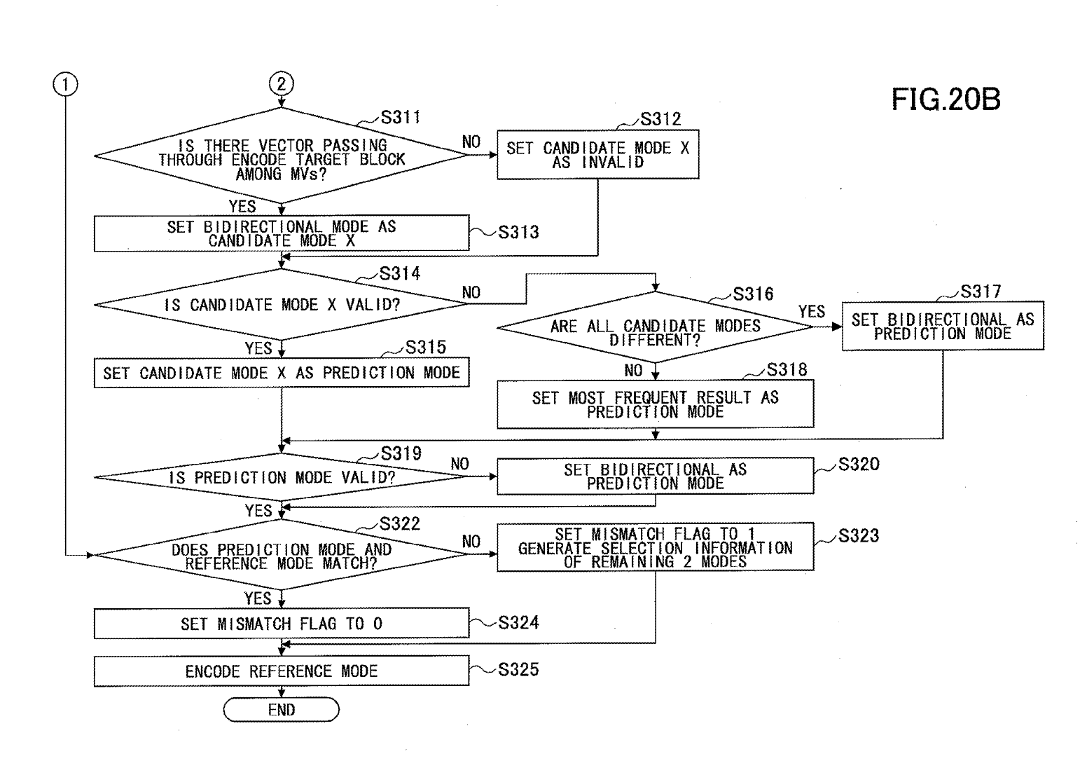

Next, a description is given of an operation of the image encoding device according to the fifth embodiment. FIGS. 20A and 20B indicate a flowchart of a reference mode encoding process according to the fifth embodiment.

In step S301 of FIG. 20A, the storage unit 201 stores encode information of images that have been encoded RPs, such as a motion vector in units of blocks, a block type, and a reference mode.

In steps S302 and S303, the first acquiring unit 202 acquires encode information of a block that has been encoded belonging to an encode target image CP, from the storage unit 201. In the example of FIG. 17, the first acquiring unit 202 acquires the reference modes A, B, and C of the left block A, the top block B, and the top right block C, respectively. When the blocks A, B, and C have been intra encoded, the first acquiring unit 202 sets the reference modes as invalid.

In step S304, the selection unit 203 selects an image RP that has been encoded, such that the encode target image is situated between an image that has been encoded and a reference image of the image that has been encoded.

In step S305, the selection unit 203 determines whether there is a plurality of the acquired RPs. When there is a plurality of the acquired RPs (YES in step S305), the process proceeds to step S306, and when there is not a plurality of the acquired RPs (NO in step S305), the process proceeds to step S308.

In steps S306 and S307, the selection unit 203 calculates an interval L between the image that has been encoded and the reference image of the image that has been encoded, and selects a pair (two pictures) of images RPs that have been encoded having the smallest interval L.

In step S308, the second acquiring unit 204 specifies a block of the image that has been encoded selected by the selection unit 203. In the second acquiring unit 204, a predetermined block is set in advance. For example, as the predetermined block, surrounding blocks including a Collocated block are set (see FIG. 18).

In step S309, the second acquiring unit 204 acquires, from the storage unit 201, a motion vector MV of the specified block.

In step S310, the first reference mode prediction unit 251 sets the reference modes A, B, and C as candidate modes A, B, and C, respectively.

In step S311 indicated in FIG. 20B, the second reference mode prediction unit 252 determines whether there is a motion vector that passes through the encode target block among the MVs acquired by the second acquiring unit 204. A motion vector passing through an encode target block means that, in the example of FIG. 19, when a block that has been decoded and a reference block of the block that has been decoded are connected by a motion vector MVB2, the motion vector MVB2 passes through the area of the encode target block CB3.

When there is a motion vector passing through the encode target block (YES in step S311), the process proceeds to step S313, and when there is no such motion vector (NO in step S311), the process proceeds to step S312.

In step S312, the second reference mode prediction unit 252 sets the candidate mode X as invalid.

In step S313, the second reference mode prediction unit 252 sets bidirectional as the candidate mode X.

In step S314, the prediction unit 205 determines whether the candidate mode X is valid. When the candidate mode X is valid (YES in step S314), the process proceeds to step S315, and when the candidate mode X is invalid (NO in step S314), the process proceeds to step S316.

In step S315, the prediction unit 205 sets the candidate mode X as the prediction mode by prioritizing the candidate mode X over other candidate modes. This is because a block having the candidate mode X is highly likely to be similar to the encode target block.

In step S316, the prediction unit 205 determines whether all candidate modes are different. When all candidate modes are different (YES in step S316), the process proceeds to step S317, and when all candidate modes are not different, (NO in step S316), the process proceeds to step S318.

In step S317, the prediction unit 205 sets bidirectional as the prediction mode. In step S318, the prediction unit 205 sets the most frequent reference mode among candidate modes A, B, and C as the prediction mode.

In step S319, the prediction unit 205 determines whether the prediction mode is valid. When the prediction mode is valid (YES in step S319), the process proceeds to step S322, and when the prediction mode is invalid (NO in step S319), the process proceeds to step S320.

In step S320, the prediction unit 205 sets bidirectional as the prediction mode. In step S321, the determination unit 206 determines the reference mode of the encode target block by block matching.

In step S322, the encoding unit 207 determines whether the prediction mode acquired from the prediction unit 205 and the reference mode determined by the determination unit 206 match. When the prediction mode acquired from the prediction unit 205 and the reference mode determined by the determination unit 206 match (YES in step S322), the process proceeds to step S324, and when the prediction mode acquired from the prediction unit 205 and the reference mode determined by the determination unit 206 do not match (NO in step S322), the process proceeds to step S323.

In step S323, the encoding unit 207 sets the mismatch flag to, for example, “1”, and generates information for selecting the remaining two modes. In step S324, the encoding unit 207 sets the mismatch flag to, for example, “0”.

In step S325, the encoding unit 207 expresses the reference mode of the encode target block by a mismatch flag, and performs arithmetic encoded on the encode data including this mismatch flag. The process of FIG. 20 is performed for each encode target block in a B picture.

As described above, according to the fifth embodiment, the second acquiring unit 204 is used to acquire the reference mode of a block having a motion vector passing through the encode target block. Accordingly, the similarity between the encode target block and a block in the temporal direction for which a reference mode is acquired becomes high. As the reference modes of similar blocks are highly likely to be the same, the prediction precision of the reference mode is increased. If the prediction precision of the reference mode is increased, the encoding may be performed by a small encoding amount, and therefore the encoding efficiency is increased.

In the fifth embodiment, the encoding unit 207 generates a mismatch flag for a reference mode and encoding is performed; however, as described in the third embodiment, the encoding may be performed with the use of a variable length encoding table.

### Sixth Embodiment

Next, a description is given of an image decoding device according to a sixth embodiment. The configuration of the image decoding device according to the sixth embodiment is the same as that illustrated in FIG. 7. Furthermore, functions relevant to prediction of the reference mode of the image decoding device according to the sixth embodiment are described by using the same reference numerals of the functions indicated in FIG. 8.

Furthermore, the image decoding device according to the sixth embodiment decodes a bit stream that has been encoded by the image encoding device according to the fifth embodiment.

The storage unit 401 stores image DRPs that have been decoded in the past, and decode information such as motion vectors in units of blocks, a block type, and a reference mode.

The first acquiring unit 402 acquires decode information that has been decoded belonging to the decode target image DP (Decoding Picture), from the storage unit 401. Here, the reference mode A of the right block A of the decode target block, the reference mode B of the top block B of the decode target block, and a reference mode C of a top right block C of the decode target block in the same screen are acquired.

A description is given of a selection process by the selection unit 403. Here, it is assumed that there are plural images that have been decoded such that a decode target image is situated between an image that has been decoded and a reference image of the image that has been decoded, and that there are images that have been decoded that sandwich a decode target image. In this case, the selection unit 403 selects a pair of two pictures in which the interval between an image that has been decoded and the reference image of the image that has been decoded is small.

The second acquiring unit 404 acquires, from the storage unit 401, a motion vector included in decode information of a specified block of the image DRP that has been decoded selected by the selection unit 403.

The prediction unit 405 determines whether the motion vector MV acquired from the second acquiring unit 404 passes through the decode target block, and when there is such a motion vector, the prediction unit 405 sets bidirectional as the candidate mode X. When there is no such motion vector, the prediction unit 405 sets the candidate mode X as invalid.

If the candidate mode X is valid, the prediction unit 405 sets the candidate mode X as the prediction mode. If the candidate mode X is invalid, the prediction unit 405 calculates a prediction mode that is a prediction value of the reference mode of the decode target block based on the reference modes A, B, and C acquired from the first acquiring unit 402. In this case, according to decision by a majority, the most frequent reference mode is set as the prediction mode. If all of the reference modes A, B, and C are different, the prediction unit 405 sets the bidirectional mode as the prediction mode.

The decoding unit 406 decodes a bit stream, and acquires reference mode information used for determining a reference mode. In this case, the mismatch flag is the reference mode information.

The determination unit 407 sets the mismatch flag according to the prediction mode acquired from the prediction unit 405. The method of setting a mismatch flag is the same as that described in the fifth embodiment. The determination unit 407 determines the reference mode corresponding to the same mismatch flag as that in the reference mode information acquired from the decoding unit 406, among the set mismatch flags. The determined reference mode is output and stored in the storage unit 401.

Accordingly, the bit stream generated by the image encoding device according to the fifth embodiment is decoded.

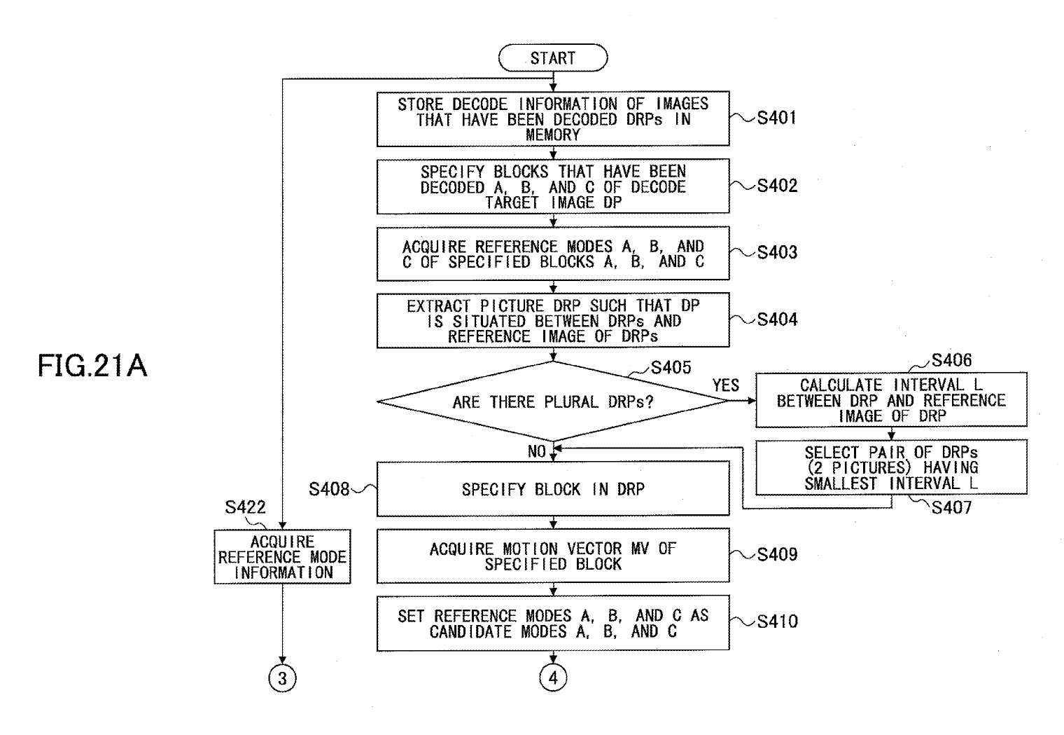

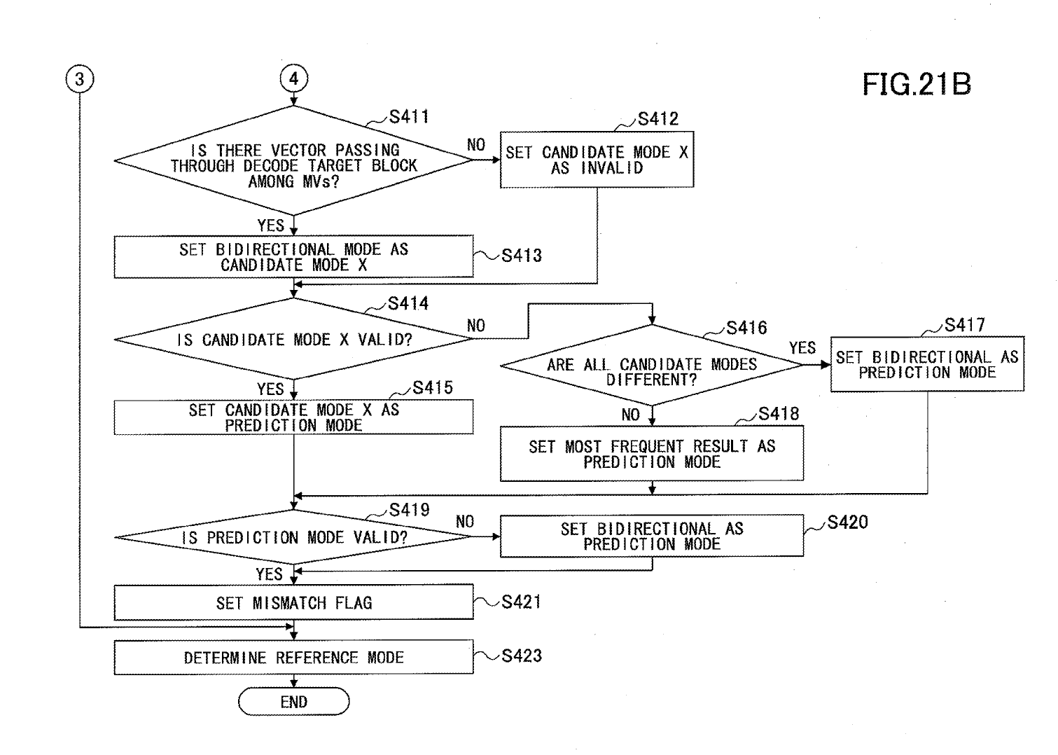

Next, a description is given of an operation of the image decoding device according to the sixth embodiment. FIGS. 21A and 21B indicate a flowchart of a reference mode decoding process according to the sixth embodiment.

In step S401 of FIG. 21A, the storage unit 401 stores decode information of images that have been decoded DRPs, such as a motion vector in units of blocks, a block type, and a reference mode.

In steps S402 and S403, the first acquiring unit 402 acquires decode information of a block that has been decoded belonging to a decode target image DP, from the storage unit 401. In the example of FIG. 17, the first acquiring unit 402 acquires the reference modes A, B and C of the left block A, the top block B, and the top right block C, respectively. When the block A, the block B, and the block C have been intra encoded, the first acquiring unit 402 sets the reference modes as invalid.

In step S404, the selection unit 403 selects an image DRP that has been decoded, such that the decode target image is situated between an image that has been decoded and a reference image of the image that has been decoded DRP.

In step S405, the selection unit 403 determines whether there is a plurality of the acquired DRPs. When there is a plurality of the acquired DRPs (YES in step S405), the process proceeds to step S406, and when there is not a plurality of the acquired DRPs (NO in step S405), the process proceeds to step S408.

In steps S406 and S407, the selection unit 403 calculates an interval L between an image that has been decoded and a reference image of the image that has been decoded, and selects a pair of images DRP that has been decoded (two pictures) having the smallest interval L.

In step S408, the second acquiring unit 404 specifies a block of an image that has been decoded selected by the selection unit 403. In the second acquiring unit 404, a predetermined block is set in advance. For example, as the predetermined block, surrounding blocks including a Collocated block are set.

In step S409, the second acquiring unit 404 acquires, from the storage unit 401, a motion vector MV of the specified block.

In step S410, the prediction unit 405 sets the reference modes A, B, and C as candidate modes A, B, and C, respectively.

In step S411 indicated in FIG. 21B, the prediction unit 405 determines whether there is a motion vector that passes through the decode target block among the MVs acquired by the second acquiring unit 404. When there is a motion vector passing through the decode target block (YES in step S411), the process proceeds to step S413, and when there is no such motion vector (NO in step S411), the process proceeds to step S412.

In step S412, the prediction unit 405 sets the candidate mode X as invalid. In step S413, the prediction unit 405 sets bidirectional as the candidate mode X.

In step S414, the prediction unit 405 determines whether the candidate mode X is valid. When the candidate mode X is valid (YES in step S414), the process proceeds to step S415, and when the candidate mode X is invalid (NO in step S414), the process proceeds to step S416.

In step S415, the prediction unit 405 sets the candidate mode X as the prediction mode by prioritizing the candidate mode X over other candidate modes. In step S416, the prediction unit 405 determines whether all candidate modes acquired from the first acquiring unit 402 are different. When all candidate modes are different (YES in step S416), the process proceeds to step S417, and when all candidate modes are not different, (NO in step S416), the process proceeds to step S418.

In step S417, the prediction unit 405 sets bidirectional as the prediction mode. In step S418, the prediction unit 405 sets the most frequent reference mode among candidate modes A, B, and C as the prediction mode.

In step S419, the prediction unit 405 determines whether the prediction mode is valid. When the prediction mode is valid (YES in step S419), the process proceeds to step S421, and when the prediction mode is invalid (NO in step S419), the process proceeds to step S420.

In step S420, the prediction unit 405 sets bidirectional as the prediction mode. In step S421, the determination unit 407 generates a mismatch flag according to a prediction mode acquired from the prediction unit 405. That is to say, the mismatch flag of the reference mode indicated by the prediction mode is set as, for example, “0”, the mismatch flag of the second most frequent reference mode is set as “10”, and the mismatch flag of other modes is set as “11”.

In step S422, the decoding unit 406 decodes the bit stream and acquires reference mode information of a decode target block. For example, the decoding unit 406 performs decoding of arithmetic encoding, and acquires a mismatch flag. In this case, the reference mode information is a mismatch flag.

In step S423, the determination unit 407 determines a reference mode corresponding to the same mismatch flag as that in the reference mode information acquired from the decoding unit 406, among the set mismatch flags. The process of FIGS. 21A and 21B is performed for each decode target block of the B picture.

As described above, according to the sixth embodiment, it is possible to determine the reference mode of the decode target block in accordance with the encoding operation in which the prediction precision of the reference mode is increased according to the fifth embodiment.

### Seventh Embodiment

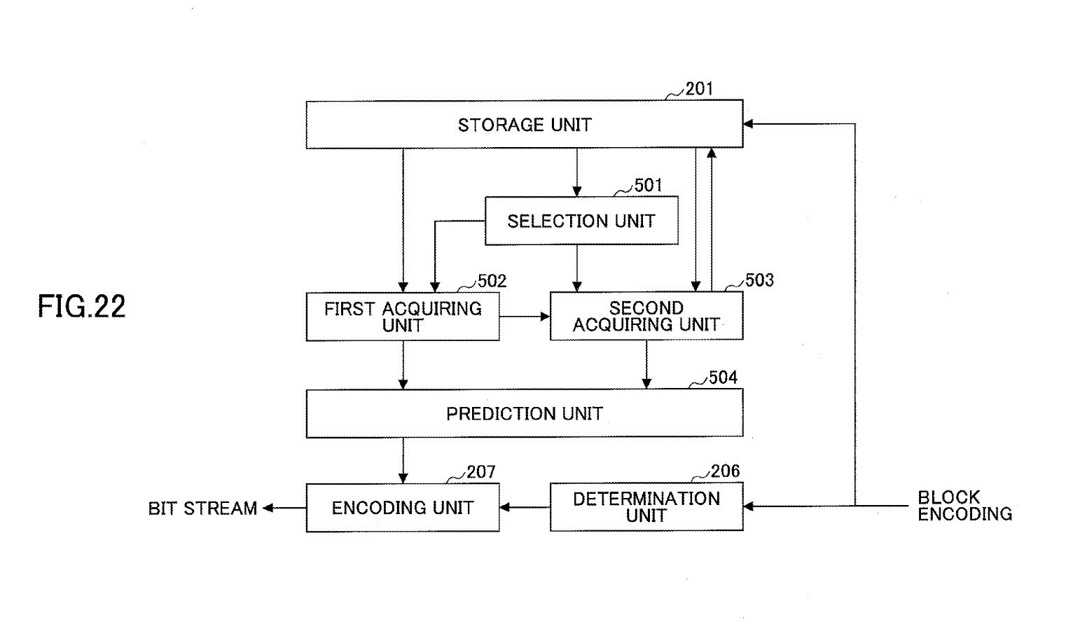

Next, a description is given of an image encoding device according to a seventh embodiment. The configuration of the image encoding device according to the seventh embodiment is the same as the configuration illustrated in FIG. 4. Functions relevant to prediction of a reference mode according to the seventh embodiment are illustrated in FIG. 22. FIG. 22 is a block diagram of functions relevant to prediction of a reference mode according to the seventh embodiment.

An image encoding device illustrated in FIG. 22 includes a storage unit 201, a selection unit 501, a first acquiring unit 502, a second acquiring unit 503, a prediction unit 504, a determination unit 206, and an encoding unit 207. The functions in FIG. 22 corresponding to those in FIG. 5 are denoted by the same reference numerals.

The seventh embodiment is described by taking as an example the encoding of the B5 picture illustrated in FIG. 9. When encoding the B5 picture, the B4 picture, the B6 picture, and the P8 picture are already encoded and these pictures B4, B6, and P8 may be referred to by the B5 picture as images that have been encoded.

The storage unit 201 has already stored encode information such as motion vectors in units of blocks, the block type, and the reference mode, relevant to the B4 picture, the B6 picture, and the P8 picture.

As illustrated in FIG. 9, the B4 picture refers to the P8 picture, the B6 picture refers to the B4 picture, and the P8 picture refers to the I0 picture. Furthermore, the B5 picture is situated between the B4 picture and the P8 picture, between the B4 picture and the B6 picture, and between the picture and the P8 picture. That is to say, the encode target image is situated between the image that has been encoded and a reference image of the image that has been encoded.

The smaller the interval between an image that has been encoded and a reference image of the image that has been encoded, the higher the reliability of prediction, and therefore the selection unit 501 selects an image that has been encoded having the smallest interval between the image that has been encoded and a reference image of the image that has been encoded.

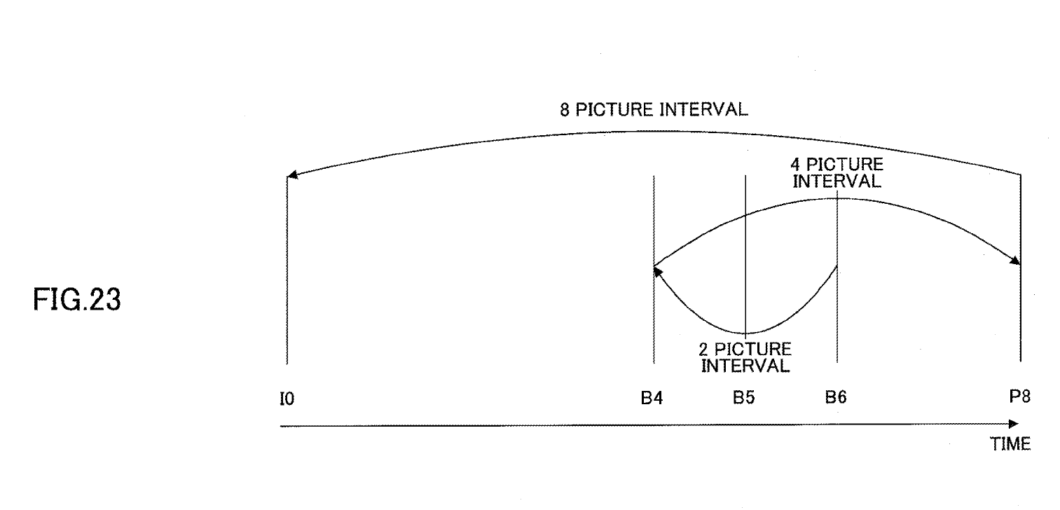

FIG. 23 illustrates a selection process of an image that has been encoded according to the seventh embodiment. As illustrated in FIG. 23, there is a four picture interval between the B4 picture and the P8 picture, a two picture interval between the B4 picture and the B6 picture, and an eight picture interval between the I0 picture and the P8 picture. Thus, the selection unit 501 selects the B6 picture. The selection unit 501 reports that the B6 picture has been selected to the first acquiring unit 502 and the second acquiring unit 503.

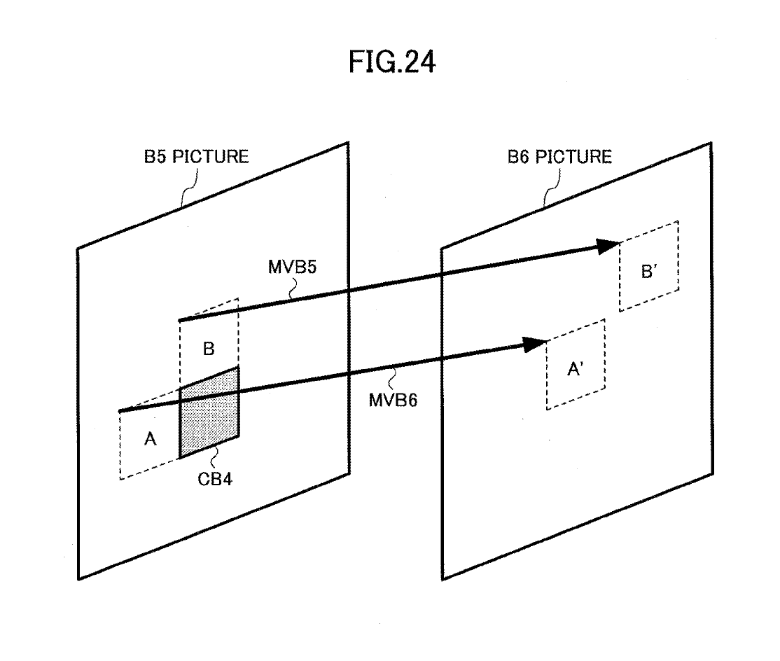

The first acquiring unit 502 acquires, from the storage unit 201, encode information of a block that has been encoded belonging to the encode target image. The encode information is, for example, a motion vector. FIG. 24 illustrates a process performed by the first acquiring unit 502 according to the seventh embodiment.

As illustrated in FIG. 24, the first acquiring unit 502 acquires, from the storage unit 201, motion vectors MVB5, MVB6 to the B6 picture, from the left block A and the top block B of an encode target block CB4. The motion vectors to the B6 picture are acquired because the B6 picture is reported as being an image that has been encoded from the selection unit 501.

When there is no motion vector to the B6 picture, when there is a motion vector to the P8 picture in the same direction, the first acquiring unit 502 appropriately performs scaling in the temporal direction and calculates a motion vector to the B6 picture. In this case, the motion vector that has undergone scaling is one third of a motion vector to the P8 picture. However, the first acquiring unit 502 sets the motion vector as invalid when the blocks A and B have been encoded by intra prediction. The first acquiring unit 502 outputs the acquired motion vector to the second acquiring unit 503.

When the block A and the block B refer to different reference images, the first acquiring unit 502 may appropriately perform scaling so that the motion vectors are directed to the B6 picture. For example, when the block A refers to the B6 picture, the motion vector of this reference is acquired, and when the block B refers to the P8 picture, the motion vector of this reference is subjected to scaling so as to be converted into a motion vector directed to the B6 picture. The first acquiring unit 502 outputs these motion vectors to the second acquiring unit 503.

The second acquiring unit 503 acquires, from the storage unit 201, encode information belonging to the image that has been encoded selected by the selection unit 501. The second acquiring unit 503 calculates, for example, a vector of an intermediate value or an average value, based on one or more motion vectors obtained from the first acquiring unit 502.

If all motion vectors acquired from the first acquiring unit 502 are invalid, the second acquiring unit 503 sets these motion vectors as zero vectors. The second acquiring unit 503 calculates a tentative motion vector from the motion vectors acquired from the first acquiring unit 502.

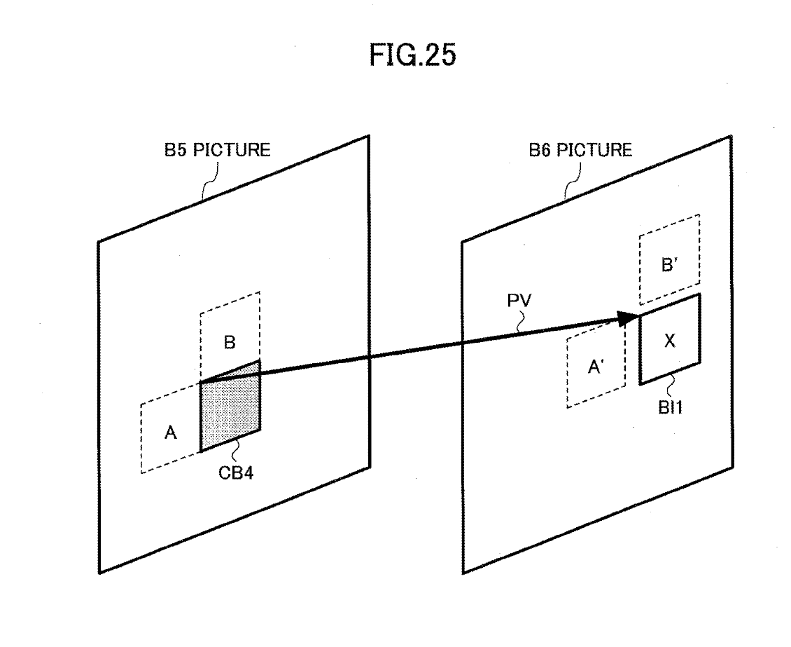

FIG. 25 illustrates an example of a tentative motion vector. By using the examples of FIGS. 24 and 25, the tentative motion vector is calculated by the following formula.

tentative vector=(motion vector MVB5+motion vector MVB6)

The second acquiring unit 503 sets the calculated average vector (pvx, pvy) as an estimated vector PV of the encode target block, and estimates the coordinates of the movement destination corresponding to the encode target block to the B6 picture.

Here, assuming that the coordinates of the encode target block are (x, y), the movement destination coordinates are (x+pvx, y+pvy). The second acquiring unit 503 acquires the reference mode of a block B11 of the B6 picture including these movement destination coordinates.

The prediction unit 504 calculates a prediction mode that is a prediction value of the reference mode of the encode target block based on the encode information obtained from the first acquiring unit 502 and the second acquiring unit 503.

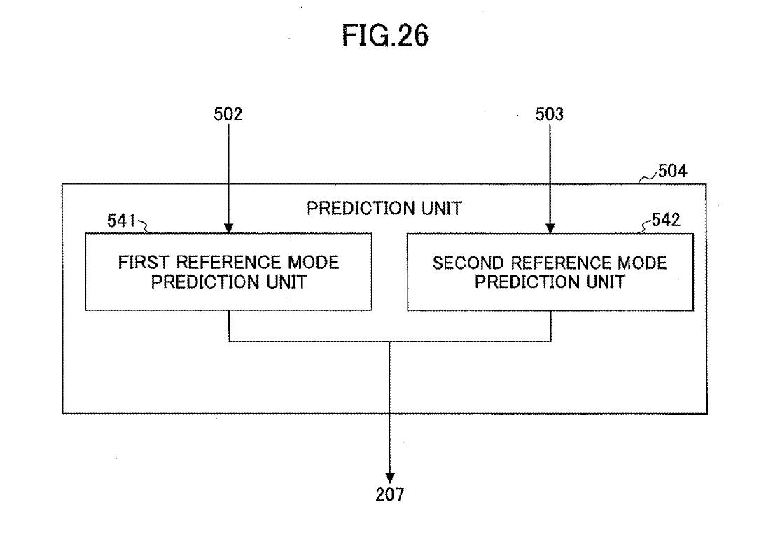

FIG. 26 is a block diagram of the prediction unit 504 according to the seventh embodiment. As illustrated in FIG. 26, the prediction unit 504 includes a first reference mode prediction unit 541 and a second reference mode prediction unit 542.

The first reference mode prediction unit 541 sets the reference mode A of a block A in the B5 picture acquired from the first acquiring unit 502 as candidate mode A, and sets the reference mode B of a block B in the B5 picture acquired from the first acquiring unit 502 as candidate mode B.

The second reference mode prediction unit 542 sets the candidate mode X based on the reference mode acquired from the second acquiring unit 503. For example, when the acquired reference mode includes a reference image in the B5 picture direction from the B6 picture, i.e., the reference mode includes reference to the B4 picture (forward direction or bidirectional), an area similar to the encode target block is considered to be included in both the B4 picture and the B6 picture. Thus, the second reference mode prediction unit 542 sets bidirectional as the candidate mode X.

Furthermore, when the acquired reference mode is a backward direction or intra encoding, the second reference mode prediction unit 542 sets the candidate mode X as invalid. Furthermore, when the movement destination coordinates specified by the tentative motion vector are outside the screen, the second reference mode prediction unit 542 sets the forward direction as the candidate mode X.

When the candidate mode X is valid, the prediction unit 504 sets the candidate mode X as the prediction mode by prioritizing the candidate mode X over other candidate modes. Next, when the candidate mode X is invalid, bidirectional is denied, and therefore if there is a candidate mode other than bidirectional among candidate modes A and B, the prediction unit 504 sets such a candidate mode as the prediction mode.

In a case where candidate modes A and B are separated by a forward direction and a backward direction, when the candidate mode X is invalid, the forward direction is denied, and therefore the prediction unit 504 sets the backward direction as the prediction mode. If both candidate modes A and B are bidirectional, or if all candidate modes are invalid, the prediction unit 504 sets bidirectional as the prediction mode.

As for the determination unit 206 and the encoding unit 207, for example, the operations may be the same as those described in the third embodiment and the fifth embodiment.

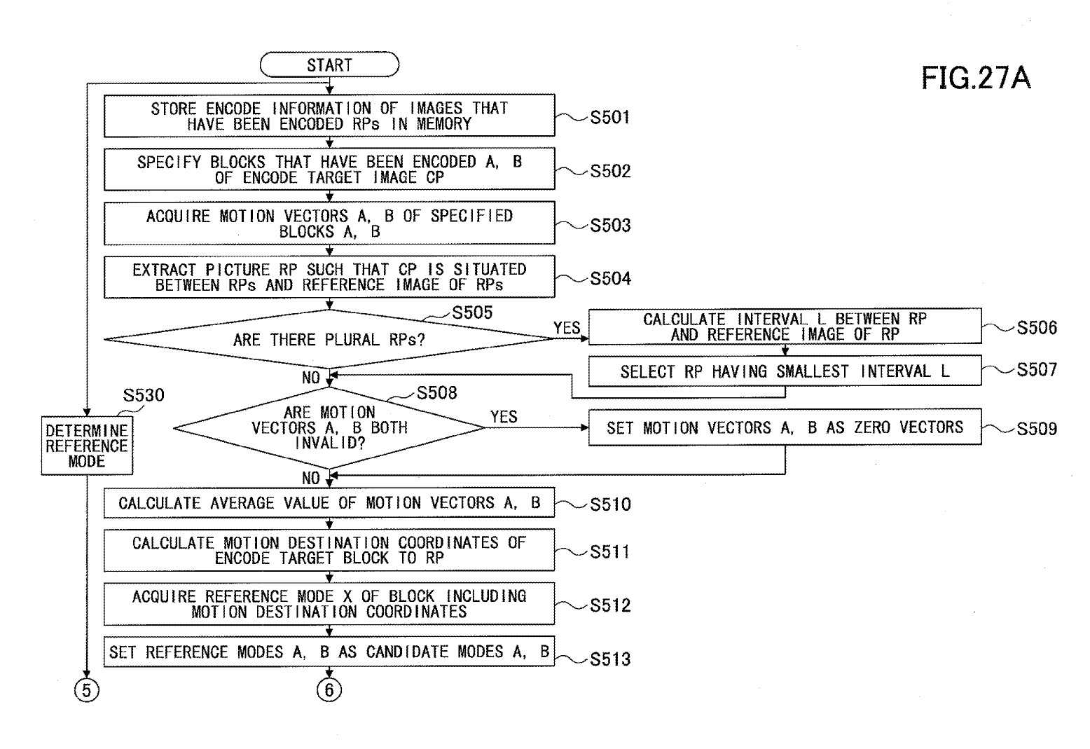

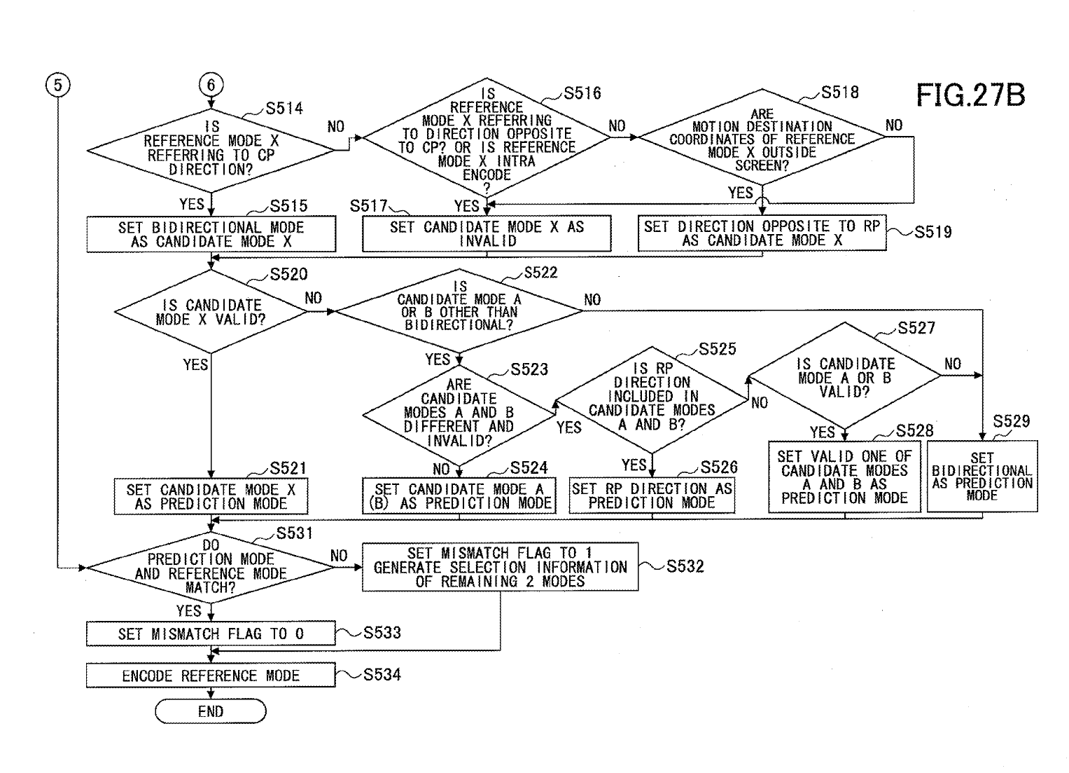

Next, a description is given of an operation of the image encoding device according to the seventh embodiment. FIGS. 27A and 27B indicate a flowchart of a reference mode encoding process according to the seventh embodiment.

In step S501 of FIG. 27A, the storage unit 201 stores encode information of images that have been encoded RPs, such as a motion vector in units of blocks, a block type, and a reference mode.

In steps S502 and S503, the first acquiring unit 502 acquires encode information of a block that has been encoded belonging to an encode target image CP, from the storage unit 201. In the example of FIG. 24, the first acquiring unit 502 acquires the motion vectors A and B and the reference modes A and B of the left block A and the top block B, respectively. When the block A and block B have been intra encoded, the first acquiring unit 502 sets the motion vectors A and B and the reference modes A and B as invalid.

In step S504, the selection unit 501 selects an image RP that has been encoded, such that the encode target image is situated between an image that has been encoded and a reference image of the image that has been encoded.

In step S505, the selection unit 501 determines whether there is a plurality of the acquired RPs. When there is a plurality of the acquired RPs (YES in step S505), the process proceeds to step S506, and when there is not a plurality of the acquired RPs (NO in step S505), the process proceeds to step S508.

In steps S506 and S507, the selection unit 501 calculates an interval L between the image that has been encoded and the reference image of the image that has been encoded, and selects an image RP that has been encoded having the smallest interval L.

In step S508, the second acquiring unit 503 determines whether the motion vectors A and B acquired from the first acquiring unit 502 are both invalid. When both motion vectors A and B are invalid (YES in step S508), the process proceeds to step S509, and when both motion vectors A and B are not invalid (NO in step S508), the process proceeds to step S510.

In step S509, the second acquiring unit 503 sets the motion vectors A and B as zero vectors.

In step S510, the second acquiring unit 503 calculates, for example, the average value of the motion vectors A and B.

In step S511, the second acquiring unit 503 calculates the movement destination coordinates of the encode target block to the selected image that has been encoded RP.

In step S512, the second acquiring unit 503 acquires a reference mode X of the block including the movement destination coordinates from the storage unit 201.

In step S513, the first reference mode prediction unit 541 sets the reference mode A of a block A in the B5 picture acquired from the first acquiring unit 502 as candidate mode A, and sets the reference mode B of a block B in the B5 picture acquired from the first acquiring unit 502 as candidate mode B.

In step S514 of FIG. 27B, the second reference mode prediction unit 542 determines whether the reference mode X acquired from the second acquiring unit 503 is referring to the encode target image CP direction. When the reference mode is referring to the CP direction (YES in step S514), the process proceeds to step S515, and when the reference mode is not referring to the CP direction (NO in step S514), the process proceeds to step S516.

In step S515, the second reference mode prediction unit 542 sets bidirectional as the candidate mode X.

In step S516, the second reference mode prediction unit 542 determines whether the reference mode X is a backward direction, or whether the reference mode X is intra encode. When the reference mode X is a backward direction or the reference mode X is intra encode, (YES in step S516), the process proceeds to step S517, and when the reference mode X not a backward direction or intra encode (NO in step S516), the process proceeds to step S518.

In step S517, the second reference mode prediction unit 542 sets the candidate mode X as invalid.

In step S518, the second reference mode prediction unit 542 determines whether the movement destination coordinates specified by the tentative motion vector are outside the screen. When the movement destination coordinates are outside the screen (YES in step S518), the process proceeds to step S519, and when the movement destination coordinates are inside the screen (NO in step S518), the second reference mode prediction unit 542 determines that this is a direct mode, and the process proceeds to step S517. When the second reference mode prediction unit 542 determines that this is a direct mode, the candidate mode X may be set according to the motion vector of an anchor block.

In step S519, the second reference mode prediction unit 542 sets a direction opposite to the RP direction as the candidate mode X.

In step S520, the second reference mode prediction unit 542 determines whether the candidate mode X is valid. When the candidate mode X is valid (YES in step S520), the process proceeds to step S521, and when the candidate mode X is invalid (NO in step S520), the process proceeds to step S522.

In step S521, the prediction unit 504 sets the candidate mode X as the prediction mode by prioritizing the candidate mode X over other candidate modes. In step S522, the prediction unit 504 determines whether the candidate mode A or B is a direction other than bidirectional. When the candidate mode A or B is a direction other than bidirectional (YES in step S522), the process proceeds to step S523, and when the candidate mode A or B is bidirectional (NO in step S522), the process proceeds to step S529.

In step S523, the prediction unit 504 determines whether the candidate modes A and B are different and invalid. When the candidate modes A and B are different and invalid (YES in step S523), the process proceeds to step S525, and when the candidate modes A and B are the same and not invalid (NO in step S523), the process proceeds to step S524.

In step S524, the prediction unit 504 sets the candidate mode A (or the candidate mode B) as the prediction mode.

In step S525, the prediction unit 504 determines whether the RP direction is included in the candidate modes A and B. When the RP direction is included (YES in step S525), the process proceeds to step S526, and when the RP direction is not included (NO in step S525), the process proceeds to step S527.

In step S526, the prediction unit 504 sets the RP direction as the prediction mode. In step S527, the prediction unit 504 determines whether the candidate mode A or the candidate mode B is valid. When the candidate mode A or the candidate mode B is valid (YES in step S527), the process proceeds to step S528, and when both the candidate mode A and the candidate mode B are invalid (NO in step S527), the process proceeds to step S529.

In step S528, the prediction unit 504 sets the valid one of candidate modes A and B as the prediction mode.

In step S529, the prediction unit 504 sets bidirectional as the prediction mode. In step S530, the determination unit 206 determines the reference mode of the encode target block by block matching.

In step S531, the encoding unit 207 determines whether the prediction mode acquired from the prediction unit 504 and the reference mode determined by the determination unit 206 match. When the prediction mode acquired from the prediction unit 504 and the reference mode determined by the determination unit 206 match (YES in step S531), the process proceeds to step S533, and when the prediction mode acquired from the prediction unit 504 and the reference mode determined by the determination unit 206 do not match (NO in step S531), the process proceeds to step S532.

In step S532, the encoding unit 207 sets the mismatch flag as, for example, “1”, and generates information for selecting the remaining two modes. In step S533, the encoding unit 207 sets the mismatch flag as, for example, “0”.

In step S534, the encoding unit 207 expresses the reference mode of the encode target block by a mismatch flag, and performs, for example, arithmetic encoding on the encode data including this mismatch flag. The process of FIG. 27 is performed for each encode target block in the B picture.

As described above, according to the seventh embodiment, the motion vectors of surrounding blocks adjacent to the encode target block are used to find a block similar to the encode target block among the images that have been encoded having a small interval between the encode target image. Accordingly, the similarity becomes high between the encode target block and the block for acquiring the reference mode, and from the viewpoint that the reference modes of similar blocks are highly likely to be the same, the prediction precision of the reference mode is further increased. If the prediction precision of the reference mode increases, the encoding may be performed by a small encoding amount, and therefore the encoding efficiency is improved.

In the seventh embodiment, the encoding unit 207 generates a mismatch flag for a reference mode and encoding is performed; however, as described in the third embodiment, the encoding may be performed with the use of a variable length encoding table.

### Eighth Embodiment

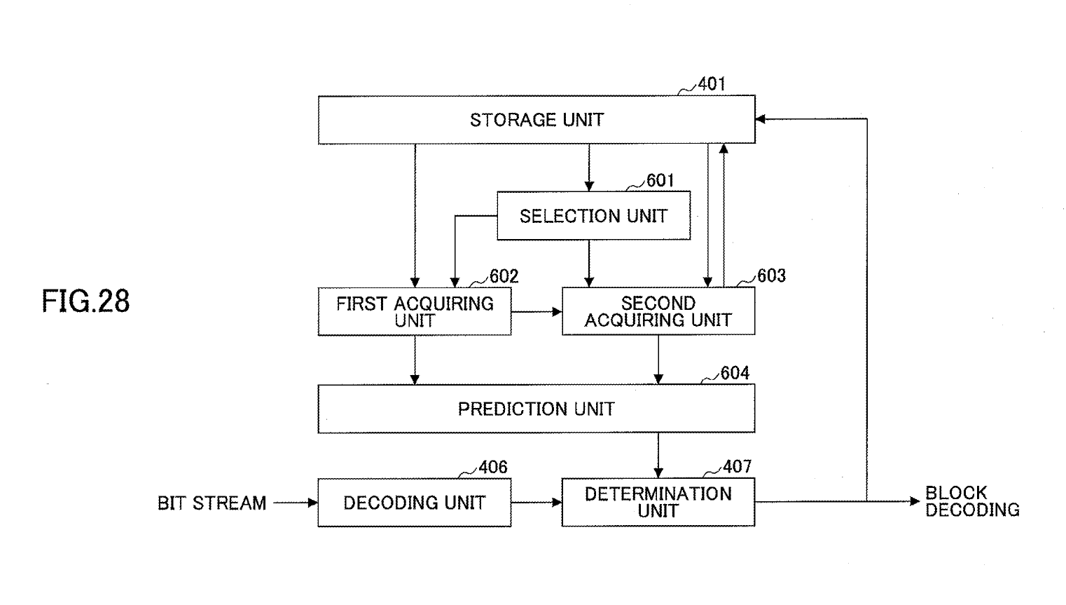

Next, a description is given of an image decoding device according to an eighth embodiment. The configuration of the image decoding device according to the eighth embodiment is the same as that illustrated in FIG. 7. Furthermore, functions relevant to prediction of the reference mode of the image decoding device according to the eighth embodiment are illustrated in FIG. 28. FIG. 28 is a block diagram of functions relevant to prediction of a reference mode according to the eighth embodiment.

The image decoding device illustrated in FIG. 28 includes a storage unit 401, a selection unit 601, a first acquiring unit 602, a second acquiring unit 603, a prediction unit 604, a decoding unit 406, and a determination unit 407. Elements in FIG. 28 corresponding to those in FIG. 8 are denoted by the same reference numerals.

The image decoding device according to the eighth embodiment decodes a bit stream that has been encoded by the image encoding device according to the seventh embodiment.

The storage unit 401 stores images DRPs that have been decoded in the past, and decode information such as motion vectors in units of blocks, a block type, and a reference mode.

A description is given of a selection process by the selection unit 601. Here, it is assumed that there are plural images that have been decoded such that the decode target image is situated between the image that has been decoded and a reference image of the image that has been decoded, and that there are images that have been decoded that sandwich a decode target image. In this case, the selection unit 601 selects an image that has been decoded having a small interval between the reference image of the image that has been decoded. The selection unit 601 reports information indicating the selected image that has been decoded to the first acquiring unit 602 and the second acquiring unit 603.

The first acquiring unit 602 acquires decode information of the block that has been decoded belonging to the decode target image, from the storage unit 401. The decode information is, for example, a motion vector and a reference mode.

The first acquiring unit 602 acquires a motion vector from the storage unit 401, if there is a motion vector indicating an image that has been decoded reported from the selection unit 601, among the motion vectors of the left block A and the top block B of the decode target block.

When there is no motion vector to the image that has been decoded reported from the selection unit 601, the first acquiring unit 602 determines whether there is a motion vector to an image that has been decoded present in the same direction. When there is such a motion vector, the first acquiring unit 602 appropriately performs temporal direction scaling, and calculates a motion vector to an image that has been decoded reported from the selection unit 601. However, when blocks A and B have been intra encoded, the first acquiring unit 602 sets the motion vectors as invalid. The first acquiring unit 602 outputs the acquired motion vector to the second acquiring unit 603.

The second acquiring unit 603 acquires, from the storage unit 401, decode information belonging to an image that has been decoded selected by the selection unit 601. The second acquiring unit 603 calculates, for example, a vector of an intermediate value or an average value, based on plural motion vectors obtained from the first acquiring unit 602.

Furthermore, when the motion vectors acquired from the first acquiring unit 602 are all invalid, the second acquiring unit 603 sets these motion vectors as zero vectors. The second acquiring unit 603 calculates a tentative motion vector from the motion vector acquired from the first acquiring unit 602.

The second acquiring unit 603 sets the calculated tentative vector as an estimate vector PV of a decode target block, and estimates the motion destination coordinates corresponding to the decode target block to the image that has been decoded selected by the selection unit 601. Next, the second acquiring unit 603 acquires a reference mode of the block including the motion destination coordinates.

The prediction unit 604 calculates a prediction mode that is a prediction value of a reference mode of the decode target block, based on the decode information obtained from the first acquiring unit 602 and the second acquiring unit 603.

The prediction unit 604 sets a reference mode A of block A in the B5 picture acquired from the first acquiring unit 602 as a candidate mode A and sets a reference mode B of block B in the B5 picture acquired from the first acquiring unit 602 as a candidate mode B.

The prediction unit 604 sets the candidate mode X in the reference mode acquired from the second acquiring unit 603. For example, when the acquired reference mode is a reference image in the B5 picture direction from the B6 picture, i.e., the reference mode includes reference to the B4 picture (forward direction or bidirectional), it is considered that the area similar to the decode target block is included in both the B4 picture and the B6 picture. Thus, the prediction unit 604 sets bidirectional as the candidate mode X.

Furthermore, when the acquired reference mode is a backward direction or intra encoding, the prediction unit 604 sets the candidate mode X as invalid. Furthermore, when the motion destination coordinates specified by the tentative motion vector are outside the screen, the prediction unit 604 sets the forward direction as the candidate mode X.

When the candidate mode X is valid, the prediction unit 604 sets the candidate mode X as the prediction mode by prioritizing the candidate mode X over other candidate modes. Next, when the candidate mode X is invalid, bidirectional is denied, and therefore if there is a candidate mode other than bidirectional among candidate modes A and B, the prediction unit 604 sets such a candidate mode as the prediction mode.

In a case where candidate modes A and B are separated by a forward direction and a backward direction, when the candidate mode X is invalid, the forward direction is denied, and therefore the prediction unit 604 sets the backward direction as the prediction mode. If both candidate modes A and B are bidirectional, or if all candidate modes are invalid, the prediction unit 604 sets bidirectional as the prediction mode.

As for the decoding unit 406 and the determination unit 407, for example, the operations may be the same as those described in the fourth embodiment and the sixth embodiment.

Accordingly, the bit stream generated by the image encoding device described with reference to the seventh embodiment is decoded.

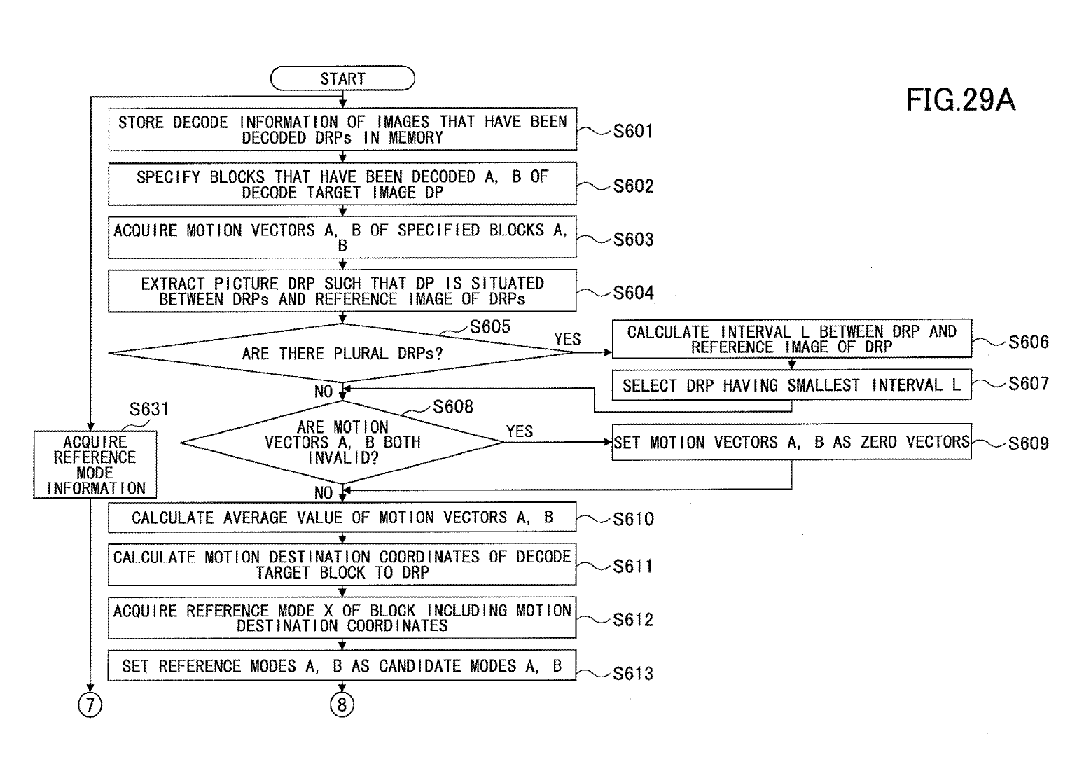

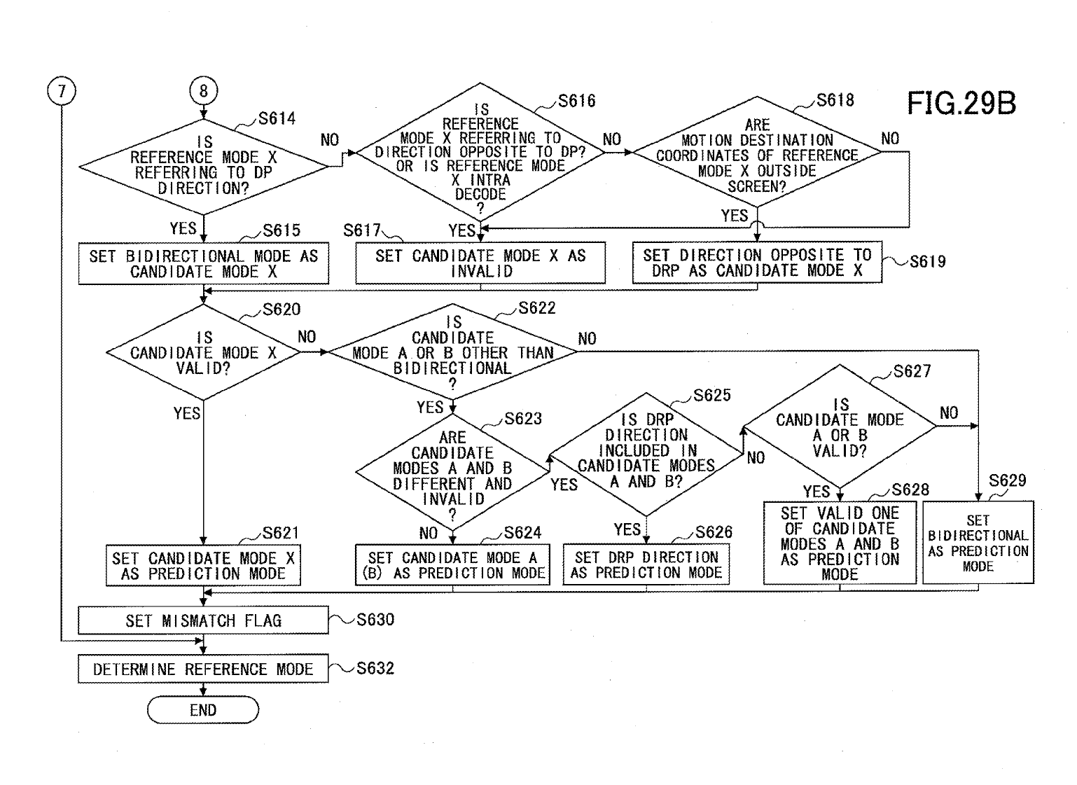

Next, a description is given of an operation of the image decoding device according to the eighth embodiment. FIGS. 29A and 29B indicate a flowchart of a reference mode decoding process according to the eighth embodiment.

In step S601 of FIG. 29A, the storage unit 401 stores decode information of images that have been decoded DRPs, such as a motion vector in units of blocks, a block type, and a reference mode.

In steps S602 and S603, the first acquiring unit 602 acquires decode information of a block that has been decoded belonging to a decode target image DP. In the example of FIG. 24, the first acquiring unit 602 acquires the reference modes A and B and the motion vectors A and B of the left block A and the top block B, respectively. When the block A and block B have been intra encoded, the first acquiring unit 602 sets the reference modes and the motion vectors as invalid.

In step S604, the selection unit 601 selects an image DRP that has been decoded, such that the decode target image is situated between an image that has been decoded and a reference image of the image that has been decoded.

In step S605, the selection unit 601 determines whether there is a plurality of the acquired DRPs. When there is a plurality of the acquired DRPs (YES in step S605), the process proceeds to step S606, and when there is not a plurality of the acquired DRPs (NO in step S605), the process proceeds to step S608.

In steps S606 and S607, the selection unit 601 calculates an interval L between the image that has been decoded and the reference image of the image that has been decoded, and selects an image DRP that has been decoded having the smallest interval L.

In step S608, the second acquiring unit 603 determines whether the motion vectors A and B acquired from the first acquiring unit 602 are both invalid. When both motion vectors A and B are invalid (YES in step S608), the process proceeds to step S609, and when both motion vectors A and B are not invalid (NO in step S608), the process proceeds to step S610.

In step S609, the second acquiring unit 603 sets the motion vectors A and B as zero vectors.

In step S610, the second acquiring unit 603 calculates, for example, the average value of the motion vectors A and B.

In step S611, the second acquiring unit 603 calculates the movement destination coordinates of the decode target block to the image that has been decoded DRP.

In step S612, the second acquiring unit 603 acquires a reference mode X of the block including the movement destination coordinates from the storage unit 401.

In step S613, the prediction unit 604 sets the reference mode A of the left block A of a decode target block in the picture acquired from the first acquiring unit 602 as candidate mode A, and sets the reference mode B of a top block B of a decode target block in the picture acquired from the first acquiring unit 602 as candidate mode B.

In step S614 of FIG. 29B, the prediction unit 604 determines whether the reference mode X acquired from the second acquiring unit 603 is referring to the decode target image DP direction. When the reference mode is referring to the DP direction (YES in step S614), the process proceeds to step S615, and when the reference mode is not referring to the DP direction (NO in step S614), the process proceeds to step S616.

In step S615, the prediction unit 604 sets bidirectional as the candidate mode X.

In step S616, the prediction unit 604 determines whether the reference mode X is a backward direction or intra encoding. When the reference mode X is a backward direction or intra encoding, (YES in step S616), the process proceeds to step S617, and when the reference mode X neither a backward direction nor intra encoding (NO in step S616), the process proceeds to step S618.

In step S617, the prediction unit 604 sets the candidate mode X as invalid. In step S618, the prediction unit 604 determines whether the movement destination coordinates specified by the tentative motion vector are outside the screen (step S618). When the movement destination coordinates are outside the screen (YES in step S618), the process proceeds to step S619, and when the movement destination coordinates are inside the screen (NO in step S618), the prediction unit 604 determines that this is a direct mode, and the process proceeds to step S617. When the prediction unit 604 determines that this is a direct mode, the candidate mode X may be set according to the motion vector of an anchor block, instead of being set as invalid.

In step S619, the prediction unit 604 sets a direction opposite to the DRP direction as the candidate mode X.

In step S620, the prediction unit 604 determines whether the candidate mode X is valid. When the candidate mode X is valid (YES in step S620), the process proceeds to step S621, and when the candidate mode X is invalid (NO in step S620), the process proceeds to step S622.

In step S621, the prediction unit 604 sets the candidate mode X as the prediction mode by prioritizing the candidate mode X over other candidate modes. In step S622, the prediction unit 604 determines whether the candidate mode A or B is a direction other than bidirectional. When the candidate mode A or B is a direction other than bidirectional (YES in step S622), the process proceeds to step S623, and when the candidate mode A or B is bidirectional (NO in step S622), the process proceeds to step S629.

In step S623, the prediction unit 604 determines whether the candidate modes A and B are different and invalid. When the candidate modes A and B are different and invalid (YES in step S623), the process proceeds to step S625, and when the candidate modes A and B are the same and not invalid (NO in step S623), the process proceeds to step S624.

In step S624, the prediction unit 604 sets the candidate mode A (or the candidate mode B) as the prediction mode.

In step S625, the prediction unit 604 determines whether the DRP direction is included in the candidate modes A and B. When the DRP direction is included (YES in step S625), the process proceeds to step S626, and when the DRP direction is not included (NO in step S625), the process proceeds to step S627.

In step S626, the prediction unit 604 sets the DRP direction as the prediction mode. In step S627, the prediction unit 604 determines whether the candidate mode A or the candidate mode B is valid. When the candidate mode A or the candidate mode B is valid (YES in step S627), the process proceeds to step S628, and when both the candidate mode A and the candidate mode B are invalid (NO in step S627), the process proceeds to step S629.

In step S628, the prediction unit 604 sets the valid one of candidate modes A and B as the prediction mode.

In step S629, the prediction unit 604 sets bidirectional as the prediction mode. In step S630, the determination unit 407 sets a mismatch flag according to the prediction mode acquired from the prediction unit 604. For example, the mismatch flag of the reference mode indicated by the prediction mode is set as “0”, the mismatch flag of the second most frequent reference mode is set as “10”, and mismatch flags of other reference modes are set as “11”.

In step S631, the decoding unit 406 decodes the bit stream and acquires reference mode information of a decode target block. For example, the decoding unit 406 performs decoding of arithmetic encoding, and acquires a mismatch flag. In this case, the reference mode information is a mismatch flag.

In step S632, the determination unit 407 determines a reference mode corresponding to the same mismatch flag as that in the reference mode information acquired from the decoding unit 406, among the set mismatch flags. The process of FIGS. 29A and 29B is performed for each decode target block of the B picture.

As described above, according to the eighth embodiment, it is possible to determine the reference mode of the decode target block in accordance with the encoding operation in which the prediction precision of the reference mode is increased according to the seventh embodiment.

### Modification

Next, a description is given of a modification. In the modification, a program for realizing the above-described image encoding method or image decoding method is recorded in a recording medium, so that the processes of the embodiments are performed by a computer system.

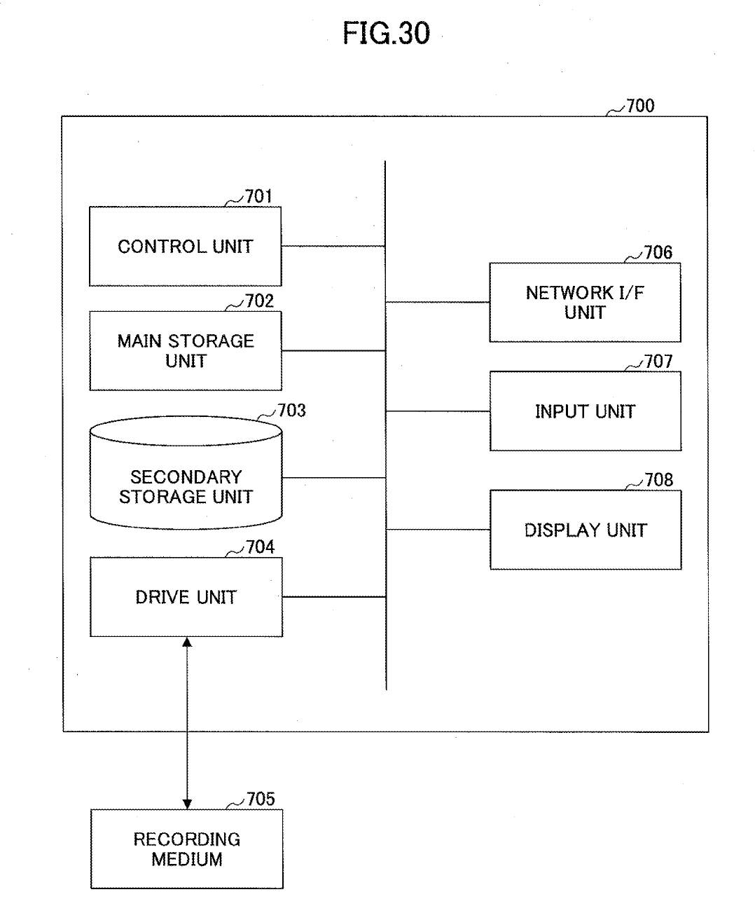

FIG. 30 is a block diagram of an example of an information processing device 700. As illustrated in FIG. 30, the video image processing device 700 includes a control unit 701, a main memory unit 702, a secondary memory unit 703, a drive device 704, a network I/F unit 706, an input unit 707, and a display unit 708. These units are connected via a bus so that it is possible to exchange data among each other.

The control unit 701 controls the respective devices and performs calculation and processing on data in the computer. Furthermore, the control unit 701 is a processor for executing programs stored in the main memory unit 702 and secondary memory unit 703, receiving data from the input unit 707 and the storage device, performing calculations and processing on the data, and outputting the data to the display unit 708 and the storage device.

The main memory unit 702 is, for example, a ROM (Read-Only Memory) or a RAM (Random Access Memory), and is a storage device for storing or temporarily saving the OS that is the basic software and programs such as application software executed by the control unit 701, and data.

The secondary memory unit 703 is, for example, a HDD (Hard Disk Drive), which is a storage device for storing data relevant to application software.

The drive device 704 is for reading a program from a recording medium 705 such as a flexible disk, and installing the program in the storage device.

The recording medium 705 stores a predetermined program. The program stored in the recording medium 705 is installed in the video image processing device 700 via the drive device 704. The installed predetermined program may be executed by the video image processing device 700.

The network I/F unit 706 is an interface between the video image processing device 700 and peripheral devices having communication functions connected via a network such as a LAN (Local Area Network) and a WAN (Wide Area Network) constructed by a wired and/or wireless data transmission path.

The input unit 707 includes a curser key, a keyboard including keys for inputting numbers and various functions, and a mouse and a slice pad for selecting a key on the display screen of the display unit 708. Furthermore, the input unit 707 is a user interface used by the user for giving operation instructions to the control unit 701 and inputting data.

The display unit 708 is constituted by a CRT (Cathode Ray Tube) or a LCD (Liquid Crystal Display), etc., and displays information according to display data input from the control unit 701.

Accordingly, the image encoding process or image decoding process described in the above embodiments may be implemented as a program to be executed by a computer. By installing this program from a server and causing a computer to execute this program, it is possible to implement the above-described image encoding process or image decoding process.

Furthermore, this program may be recorded in the recording medium 705, and cause a computer or a mobile terminal to read the recording medium 705 recording this program to implement the above-described image encoding process or image decoding process. The recording medium 705 may be various types of recording media such as a recording medium for optically, electrically, or magnetically recording information, for example, a CD-ROM, a flexible disk, and a magnet-optical disk, or a semiconductor memory for electrically recording information, for example, a ROM and a flash memory. Furthermore, the image encoding process or image decoding process described in the above embodiments may be mounted in one or more integrated circuits.

The respective embodiments are described above in detail, but the present invention is not limited to a specific embodiment, and variations and modifications may be made without departing from the scope of the present invention. Furthermore, all of or a plurality of the elements of the above-described embodiments may be combined.

According to an aspect of the embodiments, prediction precision of the reference mode is increased, and efficiency of encoding/decoding an image is improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for decoding an image divided into a plurality of blocks, the method comprising:
acquiring decode information of a block that has been decoded in a decode target image, from a storage unit storing the decode information of the block that has been decoded and decode information of each block in an image that has been decoded;
selecting, from a plurality of the images that have been decoded, an image that has been decoded, such that the decode target image is situated between the selected image that has been decoded and a reference image of the selected image that has been decoded;
acquiring, from the storage unit, decode information of a predetermined block in the selected image that has been decoded;
predicting a reference mode indicating a prediction direction of a decode target block that is able to refer to images that have been decoded in plural directions, by using the acquired decode information of the block that has been decoded and the acquired decode information of the predetermined block;
decoding reference mode information for determining the reference mode of the decode target block from encode data; and
determining the reference mode of the decode target block from the reference mode that has been predicted and the reference mode information that has been decoded.

2. The method according to claim 1, wherein
the selecting includes selecting the image that has been decoded having a smallest interval between the image that has been decoded and the reference image of the image that has been decoded.

3. The method according to claim 1, wherein
the acquiring includes acquiring the decode information of the predetermined block that is a block located at a same position as the decode target block.

4. The method according to claim 3, wherein
the predicting includes predicting the reference mode that is a most frequent reference mode among reference modes included in the decode information of the block that has been decoded and reference modes included in the decode information of the predetermined block.

5. The method according to claim 1, wherein
the acquiring includes acquiring the decode information of the predetermined block that is a block having a motion vector passing through the decode target block, among surrounding blocks including a block located at a same position as the decode target block.

6. The method according to claim 1, wherein
the acquiring includes
acquiring a motion vector of the block that has been decoded of which the decode information has been acquired,
generating a tentative motion vector by using the acquired motion vector, and
acquiring the decode information of the predetermined block that is a block indicated by the tentative vector from the decode target block.

7. The method according to claim 5, wherein
the predicting includes prioritizing a reference mode included in the decode information of the predetermined block over a reference mode included in the decode information of the block that has been decoded, in predicting the reference mode.

8. The method according to claim 1, wherein
the determining includes determining the reference mode from codes included in an encode table indicated by the reference mode information, based on the encode table in which reference modes and codes are associated with each other, wherein the encode table is changed such that an encode amount of the predicted reference mode is smaller than encode amounts of other reference modes.

9. The method according to claim 1, wherein
the determining includes
determining the predicted reference mode as the reference mode when the reference mode information indicates matching with the predicted reference mode, and
determining a reference mode other than the predicted reference mode as the reference mode when the reference mode information indicates mismatching with the predicted reference mode.

10. A method for encoding an image by dividing the image into a plurality of blocks, the method comprising:
acquiring encode information of a block that has been encoded in an encode target image, from a storage unit storing the encode information of the block that has been encoded and encode information of each block in an image that has been encoded;
selecting, from a plurality of the images that have been encoded, an image that has been encoded, such that the encode target image is situated between the selected image that has been encoded and a reference image of the selected image that has been encoded;
acquiring, from the storage unit, encode information of a predetermined block in the selected image that has been encoded;
predicting a reference mode indicating a prediction direction of an encode target block that is able to refer to decode images of images that have been encoded in plural directions, by using the acquired encode information of the block that has been encoded and the acquired encode information of the predetermined block;
determining the reference mode used by the encode target block; and
encoding the reference mode of the encode target block, from the reference mode that has been predicted and the reference mode that has been determined.

11. The method according to claim 10, wherein
the selecting includes selecting the image that has been encoded having a smallest interval between the image that has been encoded and the reference image of the image that has been encoded.

12. An image decoding device for decoding an image divided into a plurality of blocks, the image decoding device comprising:
a storage unit configured to store decode information of a block that has been decoded in a decode target image and decode information of each block in an image that has been decoded;
a first acquire unit configured to acquire the decode information of the block that has been decoded from the storage unit;
a selection unit configured to select, from a plurality of the images that have been decoded, an image that has been decoded, such that the decode target image is situated between the selected image that has been decoded and a reference image of the selected image that has been decoded;
a second acquire unit configured to acquire, from the storage unit, decode information of a predetermined block in the image that has been decoded selected by the selection unit;
a prediction unit configured to predict a reference mode indicating a prediction direction of a decode target block that is able to refer to images that have been decoded in plural directions, by using the decode information of the block that has been decoded acquired by the first acquire unit and the decode information of the predetermined block acquired by the second acquire unit;
a decode unit configured to decode reference mode information for determining the reference mode of the decode target block from encode data; and
a determine unit configured to determine the reference mode of the decode target block from the reference mode that has been predicted by the prediction unit and the reference mode information that has been decoded by the decode unit.

13. An image encoding device for encoding an image by dividing the image into a plurality of blocks, the image encoding device comprising:
a storage unit configured to store encode information of a block that has been encoded in an encode target image and encode information of each block in an image that has been encoded;
a first acquire unit configured to acquire encode information of a block that has been encoded in an encode target image from the storage unit;
a selection unit configured to select, from a plurality of the images that have been encoded, an image that has been encoded, such that the encode target image is situated between the selected image that has been encoded and a reference image of the selected image that has been encoded;
a second acquire unit configured to acquire encode information of a predetermined block in the image that has been encoded selected by the selection unit;
a prediction unit configured to predict a reference mode indicating a prediction direction of an encode target block that is able to refer to decode images of images that have been encoded in plural directions, by using the encode information of the block that has been encoded acquired by the first acquire unit and the encode information of the predetermined block acquired by the second acquire unit;
a determination unit configured to determine the reference mode used by the encode target block; and
an encode unit configured to encode the reference mode of the encode target block, from the reference mode that has been predicted by the prediction unit and the reference mode that has been determined by the determination unit.

14. A non-transitory computer-readable recording medium storing an image decoding program that causes a computer to execute a process comprising:
acquiring decode information of a block that has been decoded in a decode target image, from a storage unit storing the decode information of the block that has been decoded and decode information of each block in an image that has been decoded;
selecting, from a plurality of the images that have been decoded, an image that has been decoded, such that the decode target image is situated between the selected image that has been decoded and a reference image of the selected image that has been decoded;
acquiring, from the storage unit, decode information of a predetermined block in the selected image that has been decoded;
predicting a reference mode indicating a prediction direction of a decode target block that is able to refer to images that have been decoded in plural directions, by using the acquired decode information of the block that has been decoded and the acquired decode information of the predetermined block;
decoding reference mode information for determining the reference mode of the decode target block from encode data; and
determining the reference mode of the decode target block from the reference mode that has been predicted and the reference mode information that has been decoded.

15. A non-transitory computer-readable recording medium storing an image encoding program that causes a computer to execute a process comprising:
acquiring encode information of a block that has been encoded in an encode target image, from a storage unit storing the encode information of the block that has been encoded and encode information of each block in an image that has been encoded;
selecting, from a plurality of the images that have been encoded, an image that has been encoded, such that the encode target image is situated between the selected image that has been encoded and a reference image of the selected image that has been encoded;
acquiring, from the storage unit, encode information of a predetermined block in the selected image that has been encoded;
predicting a reference mode indicating a prediction direction of an encode target block that is able to refer to decode images of images that have been encoded in plural directions, by using the acquired encode information of the block that has been encoded and the acquired encode information of the predetermined block;
determining the reference mode used by the encode target block; and
encoding the reference mode of the encode target block, from the reference mode that has been predicted and the reference mode that has been determined.
